(19) United States
(12) Patent Application Publication
(10) Pub. No.: US 2020/0364737 A1
(43) Pub. Date: Nov. 19, 2020

(54) PLATFORM FOR VOICE APPLICATIONS

(71) Applicant: Whetstone Technologies, Inc., Wayne, PA (US)

(72) Inventors: Sanjeev Surati, Wayne, PA (US); John Iwasz, Abington, PA (US)

(73) Assignee: Whetstone Technologies, Inc., Wayne, PA (US)

(21) Appl. No.: 16/736,555

(22) Filed: Jan. 7, 2020

Related U.S. Application Data
(60) Provisional application No. 62/789,259, filed on Jan. 7, 2019.

(51) Int. Cl. G06Q 30/02; H04L 12/58; G06F 40/20

(52) U.S. Cl. CPC G06Q 30/0224; G06F 40/20; H04L 51/046; G06Q 30/0239

(57) ABSTRACT

A voice interface platform includes a script processing engine that interprets user intent arising from a user request using a script, and using the script defines how applications respond to the user requests based on the user intent; and the script defines how the applications respond based on a platform on which the user request originates and can then switch to other mechanisms such as text messaging to deliver discount codes, coupons or web links to the user. The platform provides a mechanism that allows us to offer a service to a customer to create an application on a voice-platform such as Amazon's Alexa or Google Home that may collect information from a consumer, including a mobile phone number and then send an SMS (Simple Message Service) Text to that mobile phone number that contains marketing information from the customer that is relevant to the consumer and may even be tailored based on the information that was collected. In addition to additional marketing information, the text messages may contain discount codes or links to documents containing relevant information, including redeemable coupons.

### BACKGROUND

The smart speaker market, whether such speakers are in Amazon's Alexa, Google Home, or other devices, doubled from 2017 to 2018 and is expected to triple or even make larger jumps in the future. When working with smart speakers such as Amazon's Alexa and Google Home, or devices relying solely on Voice Interfaces, however, there is no easily accessible keyboard or mouse for the user to interact with so although voice provides a convenient means of interacting in some environments, it is not always ideal.

Further, setup of smart speakers often requires at least one mobile device. The setup applications allow voice interfaces to send some data to them, but the applications are primitive and do not lend themselves to easy discovery or access of any sent fulfillment data. Leveraging SMS texting functionality to send fulfillment data to a mobile phone number is a reasonable workaround that uses a messaging mechanism familiar to users. Services to create voice interfaces and services for doing SMS texting typically require calling different platforms. Additionally, for SMS texting to work, one typically also needs to provision a phone number or short code on that platform from which to send the text messages. Since this requires two different platforms, creating solutions that combine both voice interfaces and SMS Texting requires custom coding.

In such an environment, solutions providers have little to no choice but to work on two platforms in order to use the functionality of voice and SMS. Further, those providers who work on voice solutions must become proficient in the nuances of many SMS platforms, resulting in large time expenditures for programmers.

Given the challenge that smart speaker input and output is sometimes challenging, and that speaker applications and SMS texting functionality are separate, a need exists for a way to integrate speaker functions and SMS texting into a single platform that may provide a better user experience.

### SUMMARY OF THE EMBODIMENTS

A voice interface platform includes a script processing engine that interprets user intent arising from a user request using a script, and using the script defines how applications respond to the user requests based on the user intent; and the script defines how the applications respond based on a platform on which the user request originates and can then switch to other mechanisms such as text messaging to deliver discount codes, coupons or web links to the user.

By handling the provisioning of phone numbers and short codes on behalf of customers and providing services for scripting voice interfaces and SMS Text delivery, the system and method herein offers a service that only requires customers to provide appropriate rules and messaging, and addresses the above shortcomings.

### BRIEF DESCRIPTION OF THE DRAWINGS

FIG. 1A shows an embodiment of a network environment.

FIG. 1B shows block diagrams of a computing device;

FIG. 2 shows a logic flow through the system;

FIG. 3 shows how the logic flow is implemented using Amazon Web Services;

FIG. 4 shows the details of the Step Function process referenced in FIG. 3;

FIGS. 5A and 5B show a logic flow through the scripting logic;

FIGS. 6A-6B show tables with definition elements of the Script MetaData with examples;

FIG. 7A shows tables with general elements of the Script MetaData with examples;

FIGS. 8A-8B show tables with node elements of the Script MetaData with examples;

FIGS. 9A-9C show tables with response elements of the Script MetaData with examples;

FIGS. 10A-10B show tables with card elements of the Script MetaData with examples;

FIGS. 11A-11C show tables with speech elements of the Script MetaData with examples;

FIGS. 12A-12E show tables with choice elements of the Script MetaData with examples;

FIGS. 13A-13G show tables with action elements of the Script MetaData with examples;

FIGS. 14A-14D show tables with intent elements of the Script MetaData with examples;

FIGS. 15A-15F show tables with conditions elements of the Script MetaData with examples;

FIG. 16A shows a table with bad intent elements of the Script MetaData with examples;

FIGS. 17A-17D show tables with slot elements of the Script MetaData with examples;

FIGS. 18A-18P show a sample YAML script that shows a single text message application using a “TestCo” voice-first marketing fulfillment workflow as described herein; and

FIG. 19 shows a sample YAML script related to the platform's extensibility.

### DETAILED DESCRIPTION OF THE EMBODIMENTS

Introduction

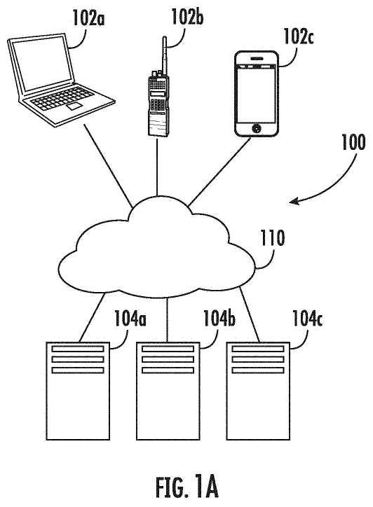

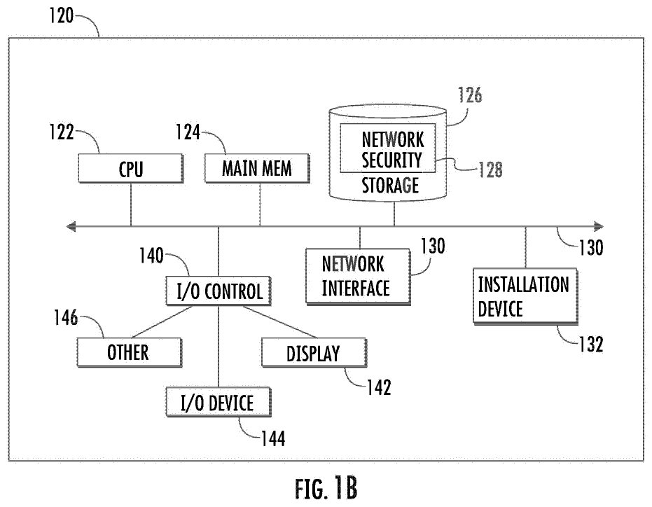

The system and method using the platform may be implemented using system and hardware elements shown and described herein. For example, FIG. 1A shows an embodiment of a network 100 with one or more clients 102a, 102b, 102c that may be local machines, personal computers, mobile devices, servers, tablets that communicate through one or more networks 110 with servers 104a, 104b, 104c. It should be appreciated that a client 102a-102c may serve as a client seeking access to resources provided by a server and/or as a server providing access to other clients.

The network 110 may be wired or wireless links. If it is wired, the network may include coaxial cable, twisted pair lines, USB cabling, or optical lines. The wireless network may operate using BLUETOOTH, Wi-Fi, Worldwide Interoperability for Microwave Access (WiMAX), infrared, or satellite networks. The wireless links may also include any cellular network standards used to communicate among mobile devices including the many standards prepared by the International Telecommunication Union such as 3G, 4G, and LTE. Cellular network standards may include GSM, GPRS, LTE, WiMAX, and WiMAX-Advanced. Cellular network standards may use various channel communications such as FDMA, TDMA, CDMA, or SDMA. The various networks may be used individually or in an interconnected way and are thus depicted as shown in FIG. 1A as a cloud.

The network 110 may be located across many geographies and may have a topology organized as point-to-point, bus, star, ring, mesh, or tree. The network 110 may be an overlay network which is virtual and sits on top of one or more layers of other networks.

A system may include multiple servers 104a-c stored in high-density rack systems. If the servers are part of a common network, they do not need to be physically near one another but instead may be connected by a wide-area network (WAN) connection or similar connection.

Management of group of networked servers may be de-centralized. For example, one or more servers 104a-c may include modules to support one or more management services for networked servers including management of dynamic data, such as techniques for handling failover, data replication, and increasing the networked server's performance.

The servers 104a-c may be file servers, application servers, web servers, proxy servers, network appliances, gateways, gateway servers, virtualization servers, deployment servers, SSL VPN servers, or firewalls.

When the network 110 is in a cloud environment, the cloud network 110 may be public, private, or hybrid. Public clouds may include public servers maintained by third parties. Public clouds may be connected to servers over a public network. Private clouds may include private servers that are physically maintained by clients. Private clouds may be connected to servers over a private network. Hybrid clouds may, as the name indicates, include both public and private networks.

The cloud network may include delivery using IaaS (Infrastructure-as-a-Service), PaaS (Platform-as-a-Service), SaaS (Software-as-a-Service) or Storage, Database, Information, Process, Application, Integration, Security, Management, Testing-as-a-service. IaaS may provide access to features, computers (virtual or on dedicated hardware), and data storage space. PaaS may include storage, networking, servers or virtualization, as well as additional resources such as, e.g., the operating system, middleware, or runtime resources. SaaS may be run and managed by the service provider and SaaS usually refers to end-user applications. A common example of a SaaS application is SALESFORCE or web-based email.

A client 102a-c may access IaaS, PaaS, or SaaS resources using preset standards and the clients 102a-c may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The clients 102a-c and servers 104a-c may be embodied in a computer, network device or appliance capable of communicating with a network and performing the actions herein. FIGS. 1A and 1B show block diagrams of a computing device 120 that may embody the client or server discussed herein. The device 120 may include a system bus 150 that connects the major components of a computer system, combining the functions of a data bus to carry information, an address bus to determine where it should be sent, and a control bus to determine its operation. The device includes a central processing unit 122, a main memory 124, and storage device 124. The device 120 may further include a network interface 130, an installation device 132 and an I/O control 140 connected to one or more display devices 142, I/O devices 144, or other devices 146 like mice and keyboards.

The storage device 126 may include an operating system, software, and a network user behavior module 128, in which may reside the network user behavior system and method described in more detail below.

The computing device 120 may include a memory port, a bridge, one or more input/output devices, and a cache memory in communication with the central processing unit.

The central processing unit 122 may be a logic circuitry such as a microprocessor that responds to and processes instructions fetched from the main memory 124. The CPU 122 may use instruction level parallelism, thread level parallelism, different levels of cache, and multi-core processors. A multi-core processor may include two or more processing units on a single computing component.

The main memory 124 may include one or more memory chips capable of storing data and allowing any storage location to be directly accessed by the CPU 122. The main memory unit 124 may be volatile and faster than storage memory 126. Main memory units 124 may be dynamic random access memory (DRAM) or any variants, including static random access memory (SRAM). The main memory 124 or the storage 126 may be non-volatile.

The CPU 122 may communicate directly with a cache memory via a secondary bus, sometimes referred to as a backside bus. In other embodiments, the CPU 122 may communicate with cache memory using the system bus 150. Cache memory typically has a faster response time than main memory 124 and is typically provided by SRAM or similar RAM memory.

Input devices may include smart speakers, keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include the same smart speakers, video displays, graphical displays, speakers, headphones, inkjet printers, laser printers, and 3D printers.

Additional I/O devices may have both input and output capabilities, including haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures.

In some embodiments, display devices 142 may be connected to the I/O controller 140. Display devices may include liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays.

The computing device 120 may include a network interface 130 to interface to the network 110 through a variety of connections including standard telephone lines LAN or WAN links (802.11, T1, T3, Gigabit Ethernet), broadband connections (ISDN, Frame Relay, ATM, Gigabit Ethernet, Ethernet-over-SONET, ADSL, VDSL, BPON, GPON, fiber optical including FiOS), wireless connections, or some combination of any or all of the above. Connections may be established using a variety of communication protocols. The computing device 120 may communicate with other computing devices via any type and/or form of gateway or tunneling protocol such as Secure Socket Layer (SSL) or Transport Layer Security (TLS). The network interface 130 may include a built-in network adapter, network interface card, PCMCIA network card, EXPRESSCARD network card, card bus network adapter, wireless network adapter, USB network adapter, modem or any other device suitable for interfacing the computing device 120 to any type of network capable of communication and performing the operations described herein.

The computing device 120 may operate under the control of an operating system that controls scheduling of tasks and access to system resources. The computing device 120 may be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein.

The computer system 120 may be any workstation, telephone, desktop computer, laptop or notebook computer, netbook, tablet, server, handheld computer, mobile telephone, smartphone or other portable telecommunications device, media playing device, a gaming system, mobile computing device, or any other type and/or form of computing, telecommunications or media device that is capable of communication.

Platform

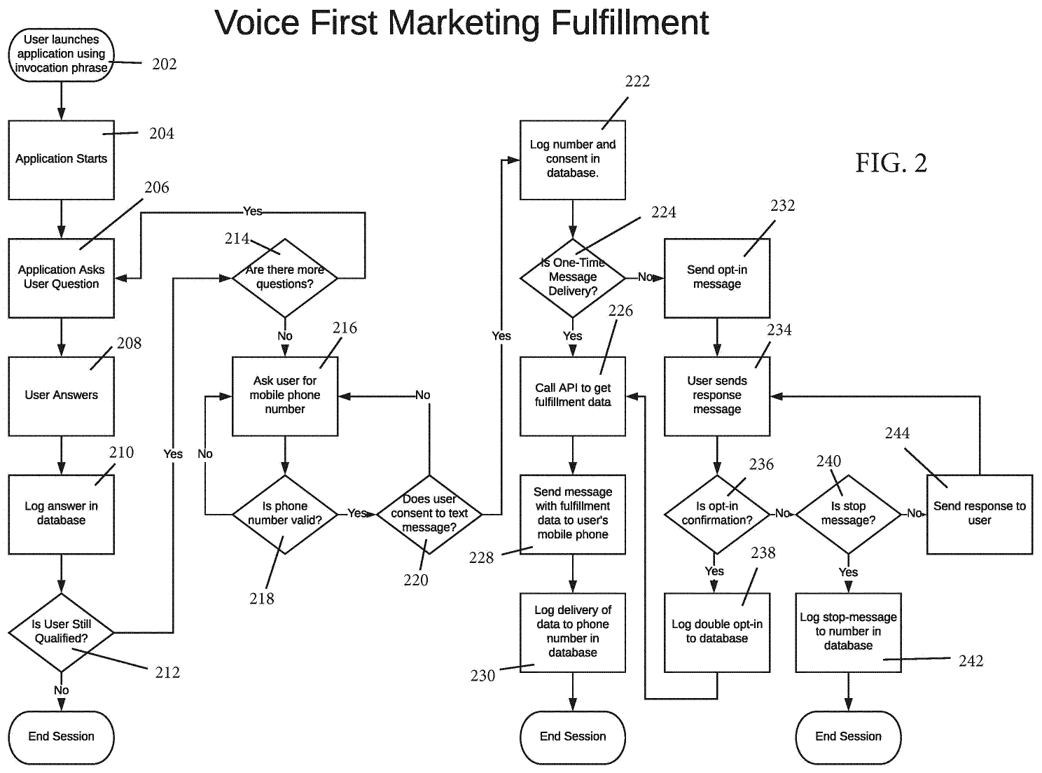

With reference to FIG. 2, the platform includes the following features and capabilities. In this workflow, the voice interface takes the user through a conversation, asking questions where a user provides answers or asks for more information. Based on answers and rules, the voice interface may choose to end the conversation, or the user may choose to end the conversation.

The platform provides a phone number or short code from an SMS Texting Service and provides a conversational interface for the smart speaker using messaging and rules as well as an SMS Text based interface using similar messaging and rules. The SMS Text based interface may be tied back to the phone number or short code. Script files for the conversational interface may be uploaded to a cloud-based storage location for consumption by the platform. And the platform itself may be implemented in a public cloud infrastructure.

With specific reference to FIG. 2, a user activates the voice interface by speaking an invocation phrase to their smart speaker (e.g. “Alexa, open MyDrug Savings”) 202. This starts the application asking some questions to ensure the user may be qualified to receive predetermined information (steps 206-212).

In a series of qualification steps, the application asks a user a question 206, receives an answer 208, logs the answer in a database 210, and confirms if the user is qualified 212 or if there are other questions 214. If these steps are completed and the user is still qualified, the voice interface eventually asks the user to provide a mobile phone number 216.

Upon receiving the phone number, the voice interface asks the user to validate the number 218 and consent to receive text messages 220.

If the user consents, the phone number and consent are written to a database 222 and the back-end platform sends SMS Text messages or MMS (Multimedia Messaging Service) Image messages to the customer.

If the SMS Text messages are single delivery 224, the back-end platform gets a unique discount code for the customer from the database 226, sends the code 228, and records the delivery 230.

If the SMS Text messages represent a continuous delivery channel, an opt-in message may be sent to the user and logged in a database 232. If the user texts an opt-in response (e.g. “YES”) 234 and the response is positive 238, that is logged in a database 238 and the back-end platform gets a unique discount code for the customer from the database, and the delivery of the information is written to a back-end relational database steps 226-230).

Subsequent messaging may also be sent to the phone number using SMS Text or images using MMS. All message delivery may be written to a back-end relational database.

If the user texts an opt-out response (e.g. “STOP”) 240, that is logged in a database 242 and further SMS Text communication with the mobile phone number stops, otherwise the user receives a response 244.

The system may provision a phone number or short code using an SMS Texting service-in this case Twilio or Amazon SNS. The provider may vary. For example, the system may also send MMS messages which contain embedded images using Twilio. SNS could be used without needing to provision a long code or short code.

The system models a conversational interface for the smart speaker using messaging and rules as well as an SMS Text based interface using similar messaging and rules. The SMS Text based interface may be tied back to the phone number or short code.

YAML (or other formatting/standards like JSON) script files for the conversational interface are uploaded to a cloud-based storage location for consumption by the platform. The files are stored in Amazon's S3 buckets 250. Certain metadata may be used to describe the conversation. The use of script files uploaded to a storage location is just a way to make this happen. Storage files are also stored using an in-memory cache to improve performance 251.

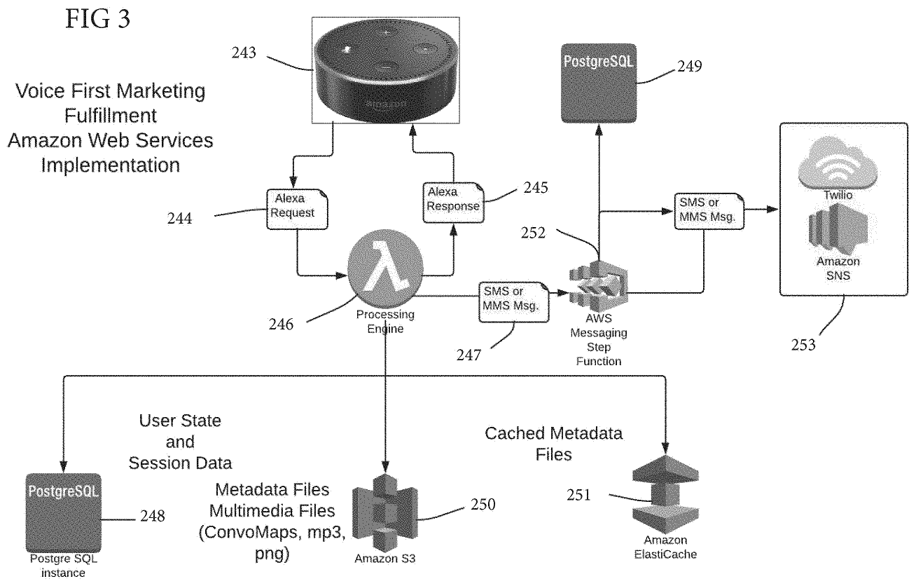

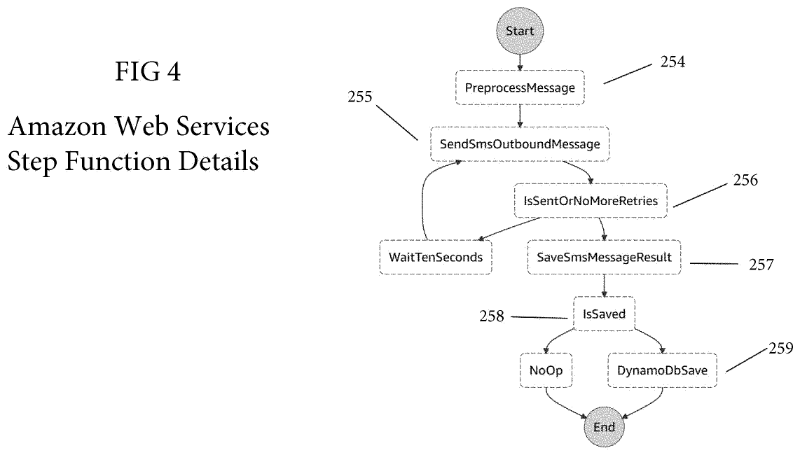

The platform itself may be implemented in a public cloud infrastructure. The platform may also be implemented outside of a public cloud infrastructure, but if that were done, similar services would still need to be leveraged. The current platform implementation is illustrated in FIGS. 3 and 4.

A user may activate the voice interface by speaking an invocation phrase to their smart speaker (e.g. Alexa, open MyDrug Savings) 243.

The voice interface platform takes the user through a conversation, asking questions where a user provides answers or asks for more information. Based on answers and rules, the voice interface may choose to end the conversation, or the user may choose to end the conversation. The voice platform interprets user intent and a script defines how any application will respond to what the user says. One implementation may use an Amazon Lambda 246 as the engine that processes user requests 244, returns responses to the smart speaker 245, and sends SMS Text and MMS Image messages 247.

Messaging and user answers for the voice interface may be written to a back-end relational database for reporting and auditing 248.

Writes to the database may be implemented using a PostgreSQL database 248, but it could be done using a different database. In order to maintain performance, the writes may be sent to a workflow system, in this case Amazon's Step Functions, where another process picks up the requests and does the actual writes. The use of the workflow system may be a performance enhancement and not required. Subsequent references to writes to the database may use this combination of a PostgreSQL database and a queueing system. User interaction that occurs between the user and the voice interface may be logged as well as messages sent to the user over SMS or MMS 249.

The voice interface may eventually ask the user to provide a mobile phone number. The mobile phone number may also be pulled from the user's settings if it is available.

Upon receiving the phone number, the voice interface asks the user to validate the number and consent to receive text messages. This step may be used to comply with text messaging regulations. Additional validation checks may be performed on the provided phone number, including validating that the number is a mobile phone number and not a land line.

If the user consents, then an Amazon Step Function is sent a message that contains the user's phone number and the SMS or MMS message to send 247. The user's consent to receive a message is stored in the user's interaction history 248.

The Step Function runs a preprocess step to replace token values, if present, in the message with redeemable discount codes retrieved from a database 245. If the discount code is a single-use code, it is marked as used and not available for reuse.

Once the discount codes are merged into the function, the SendSmsOutboundProcess 255 dispatches the SMS or MMS message to Twilio or Amazon's Simple Notification Service 235. This process includes retry logic 256. If the message fails to be sent, the workflow process automatically retries sending the message. The number of retries is configurable in the workflow process settings.

A record of the message, including contents, destination phone number, and whether the message was sent successfully or not is saved to the database for reporting and auditing as well as compliance 249, 257.

If the PostgreSQL database is not accessible, a record of the message, including contents, destination phone number, and whether the message was sent successfully is saved to Amazon's DynamoDb database 259.

If the SMS Text messages or MMS messages are single delivery, the back-end platform gets a unique discount code for the customer from the database. The delivery of the information to the phone number is written to a back-end database 249. The call to the database could come from another data source, but it should result in a unique code. Writing the information to the database may be used to support logging and auditing.

If the SMS Text messages or MMS messages represent a continuous delivery channel, an opt-in message is sent to the user and written to a database. If the user texts an opt-in response (e.g. “YES”), that is written to a database and the back-end platform gets a unique discount code for the customer from the database. The delivery of the information is written to a back-end database. Writes to the database are required for logging, auditing and compliance. The call to the database could come from another data source, but it should result in a unique code.

Subsequent messaging may also be sent to the phone number using SMS Text or MMS. All message delivery may be written to a back-end database and recorded against the phone number it was delivered to. Writes to the database are required for logging, auditing and compliance.

If the user texts an opt-out response (e.g. “STOP”), that is logged in a database and further SMS Text or MMS communication with the mobile phone number stops. Handling the opt-out response may be necessary for compliance. Writes to the database may be used for logging, auditing and compliance.

Rather than delivering discount codes to customers via text, this mechanism could also be used to send links to documents, web pages, or images. The calls to get these links would require calls to additional APIs.

Note that although collecting contact information by asking the user for permission to access their contact info does not necessarily provide a smooth experience, that's not to say that doing so would be unreasonable. The mechanism could be updated to also allow the user to opt-in to give the application access to their email address and mobile-phone number. In the case of the mobile-phone number, that could be used as a default rather than requiring the user always provide their phone number. The email address could be used as an alternative delivery mechanism where the application sends the discount codes or links over email.

Application Script Processing

This section provides a high-level overview of the platform's script processing engine 246. The platform's voice and NLP application architecture may use a script processing engine with scripts developed as YAML files (though this is non-limiting) using different elements to control request/response flow and conditional processing.

Script File Basics

The script files may be loaded into the platform engine using an Admin API (Application Programming Interface). The files may be uploaded and written into file storage and then cached using an optimized binary format. The scripts may be segmented and stored using a database schema, however, accessing the files in entirety through a cache may provide a faster throughput.

The scripts may be versioned and then bound to a client platform (e.g. Alexa, Google Actions, SMS, etc.) using platform specific identifiers (ids). The platform specific ids may be tied to specific script versions and may be updated to point to other versions as necessary. A single script may be used to support multiple platforms. Two scripts may be linked via a common id like a phone number to switch from one mode to another, e.g., start from voice and then switch to text messaging.

The versioning mechanism may allow for development of new versions of an application against a development configuration while a production version of the application runs unhindered.

NLP Application Overview

An NLP application may accept verbal input or manual input by a user and then map that input to intents. The intents may have variables defined called slots that are passed to an application so it may determine the next logical response.

The platform may maintain a persistent state for a user so it may remember prior selections if a user returns to the application. It may identify if a new or existing user id coming in, and any context data from the current or prior sessions.

The intents and context may be used to drive a response that is then returned to the user. The requests and responses may be fully audio driven, such as via a smart speaker, or text driven such as via text messaging or a messaging application.

The script allows for centralizing functionality for an NLP application using a common set of cross-platform intents and responses. It also allows for storage of variables, conditional processing (i.e. if/then), localization and platform specific behavior.

Script Elements

A more complete documentation on script elements is provided in the Platform Script MetaData documentation in the figures below that provide high level documentation of the elements that comprise the platform scripting mechanism for supporting voice and other NLP applications.

In the figures,

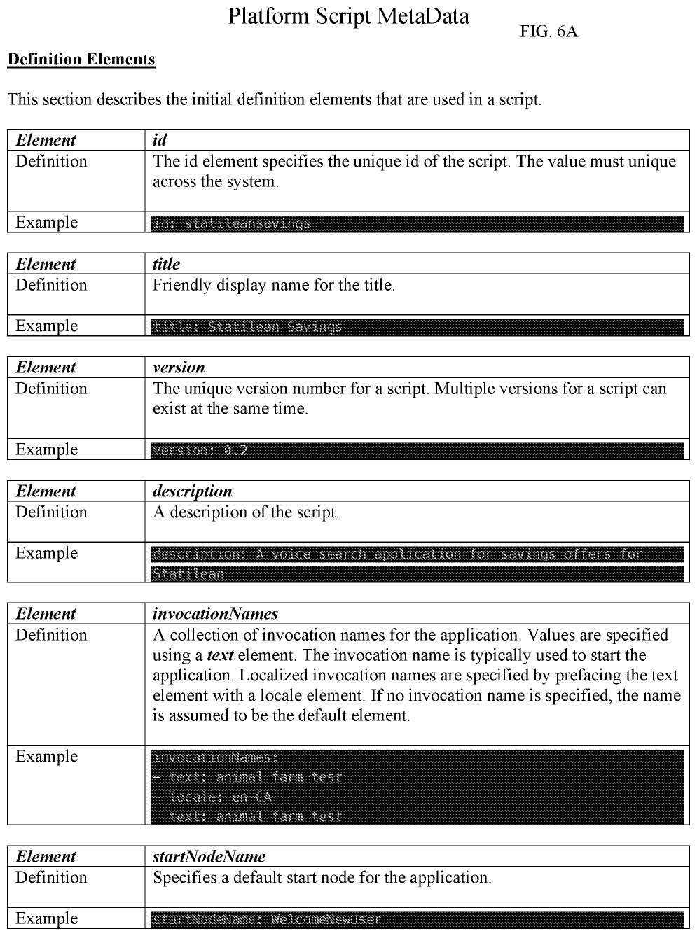

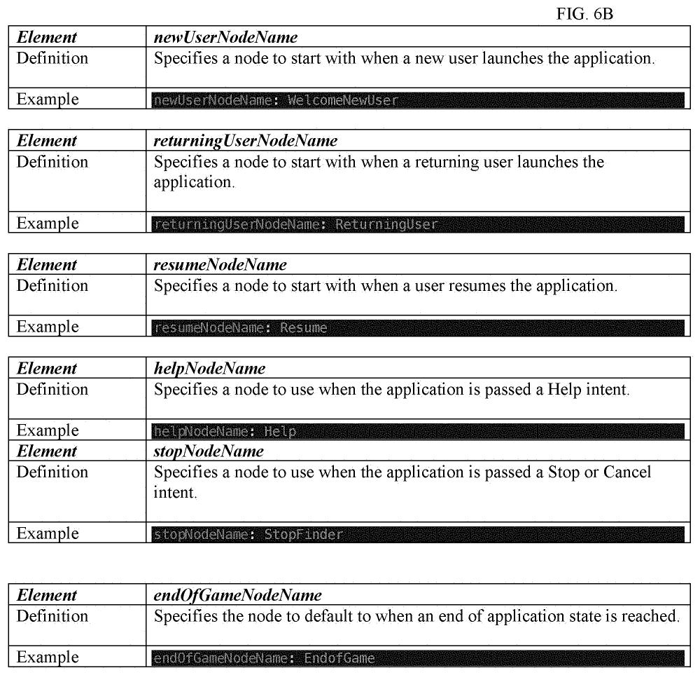

FIGS. 6A-6B show definition elements of the Script MetaData with examples;

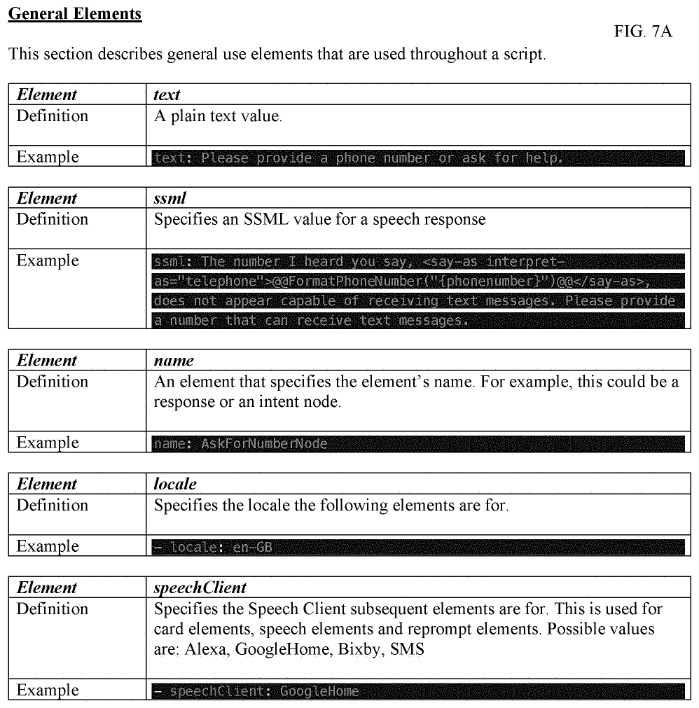

FIG. 7A shows general elements of the Script MetaData with examples;

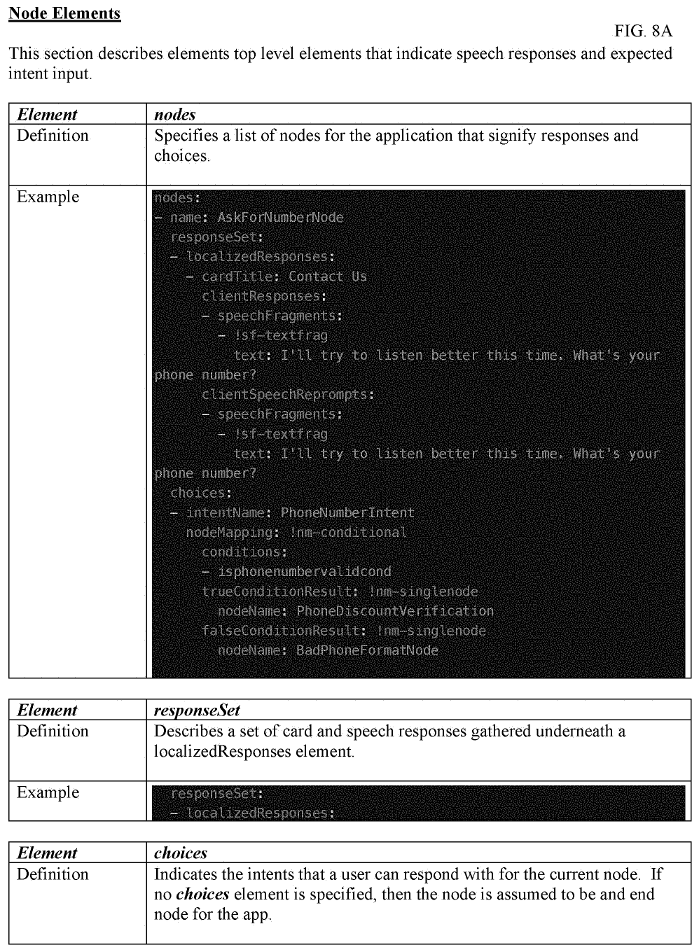

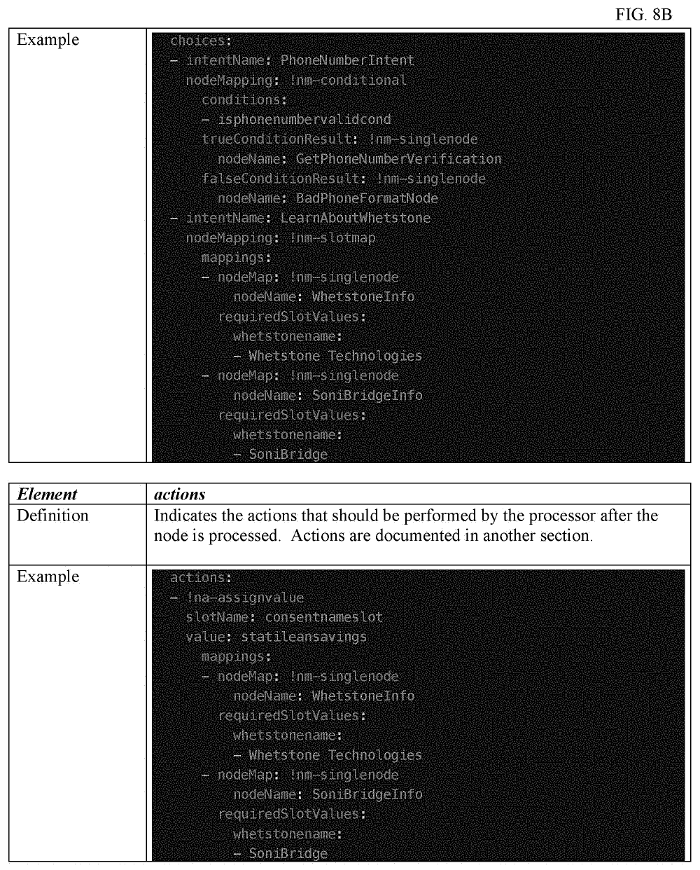

FIGS. 8A-8B show node elements of the Script MetaData with examples;

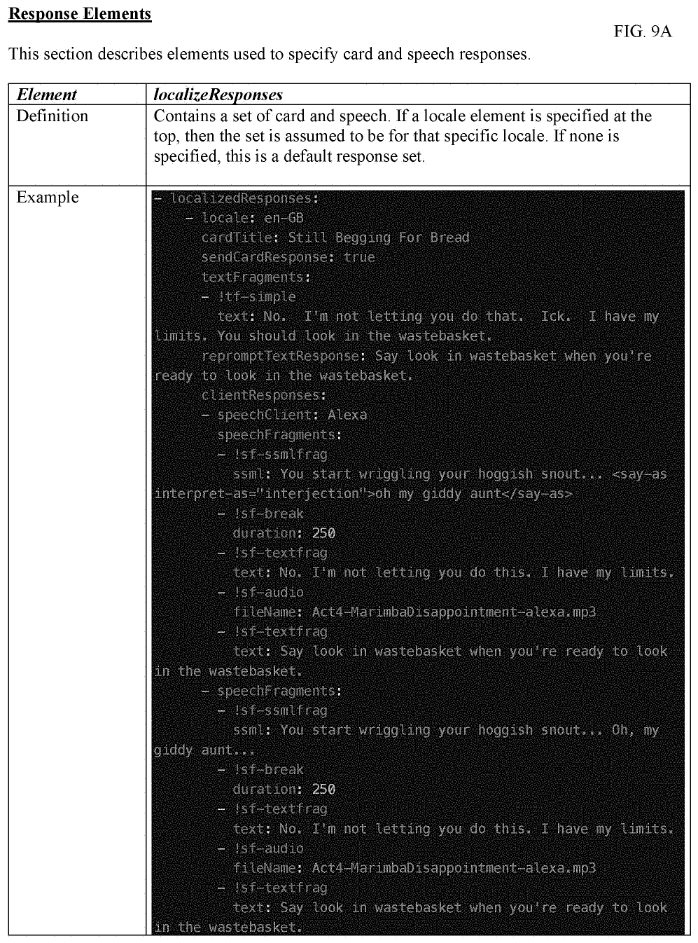

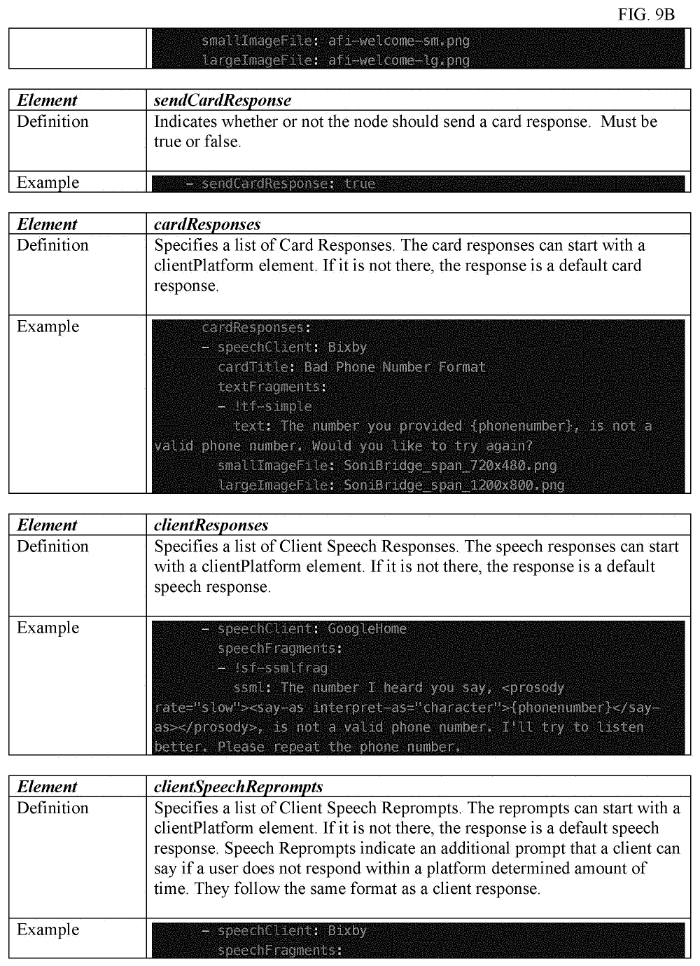

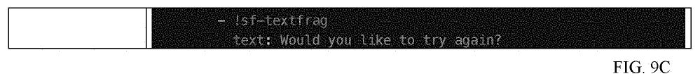

FIGS. 9A-9C show response elements of the Script MetaData with examples;

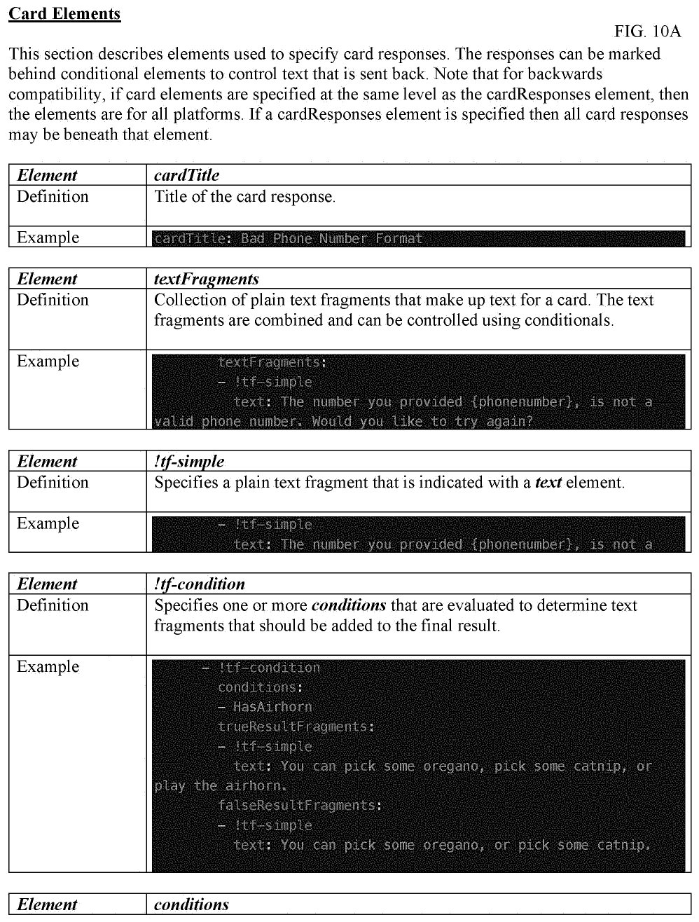

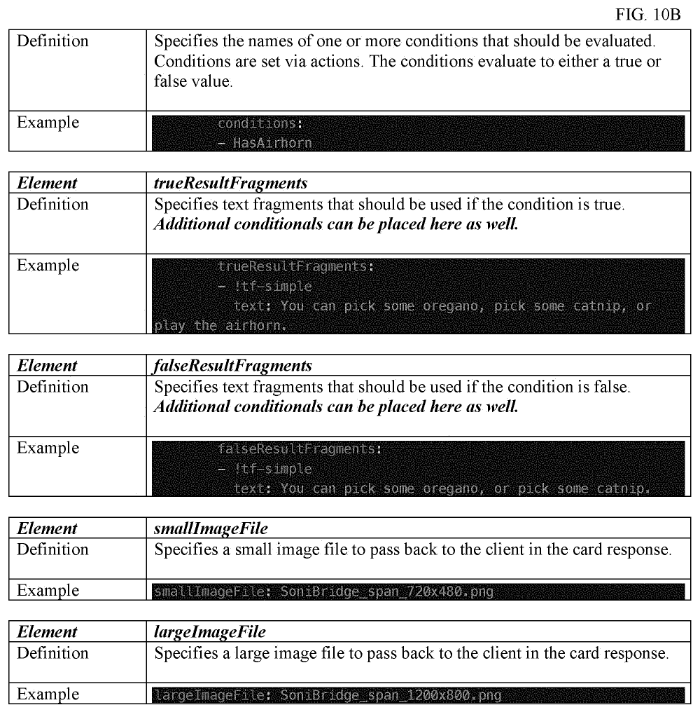

FIGS. 10A-10B show card elements of the Script MetaData with examples;

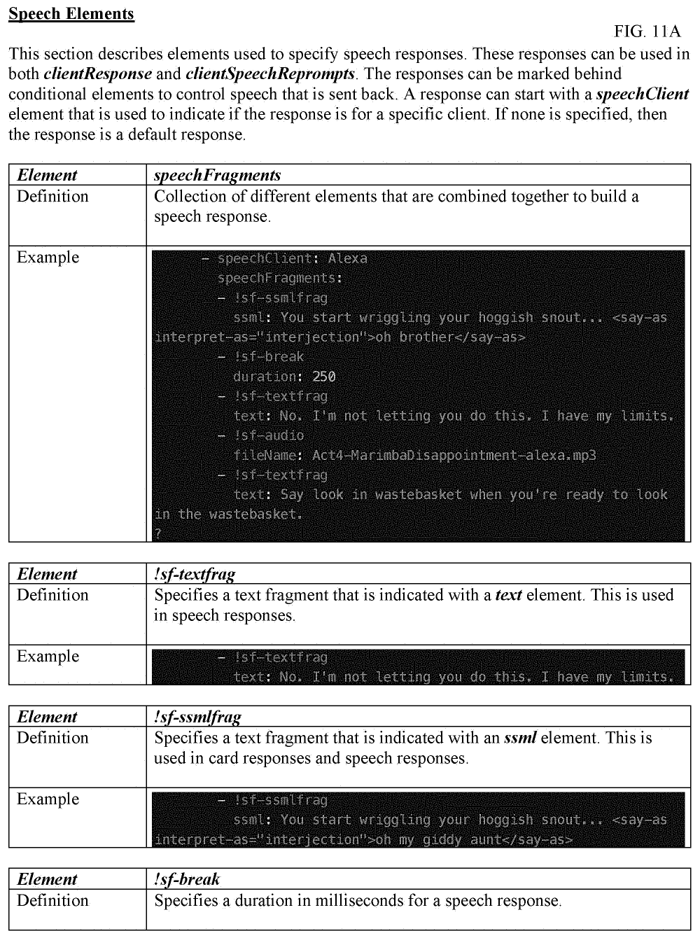

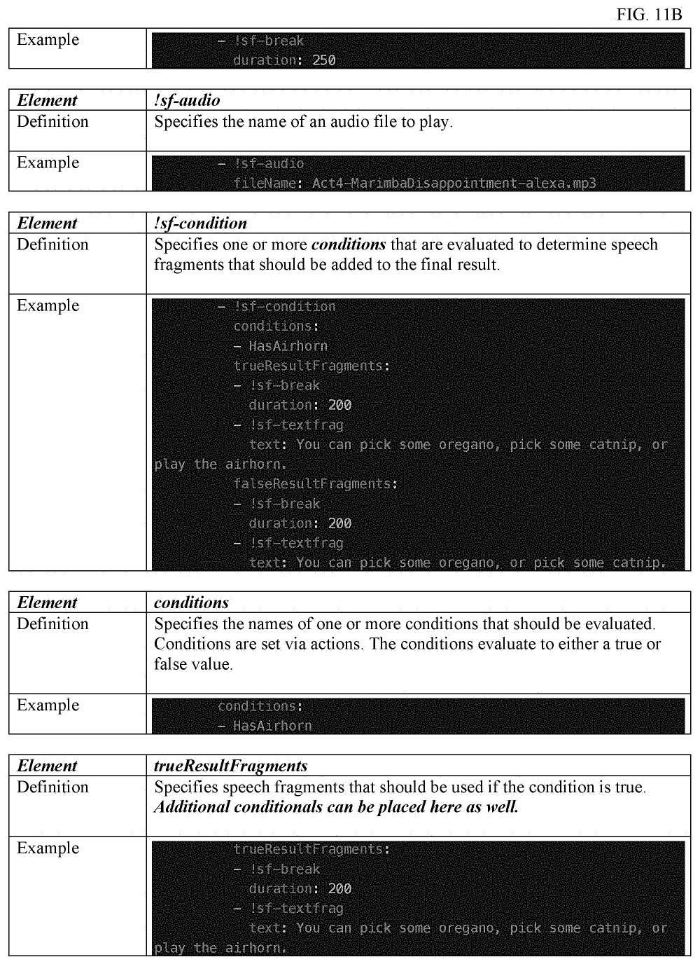

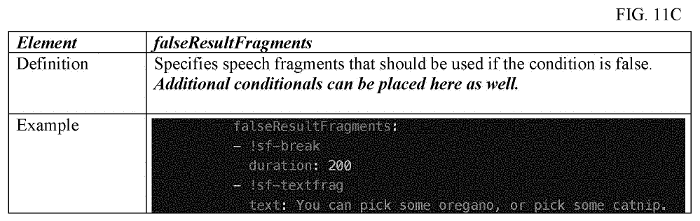

FIGS. 11A-11C show speech elements of the Script MetaData with examples;

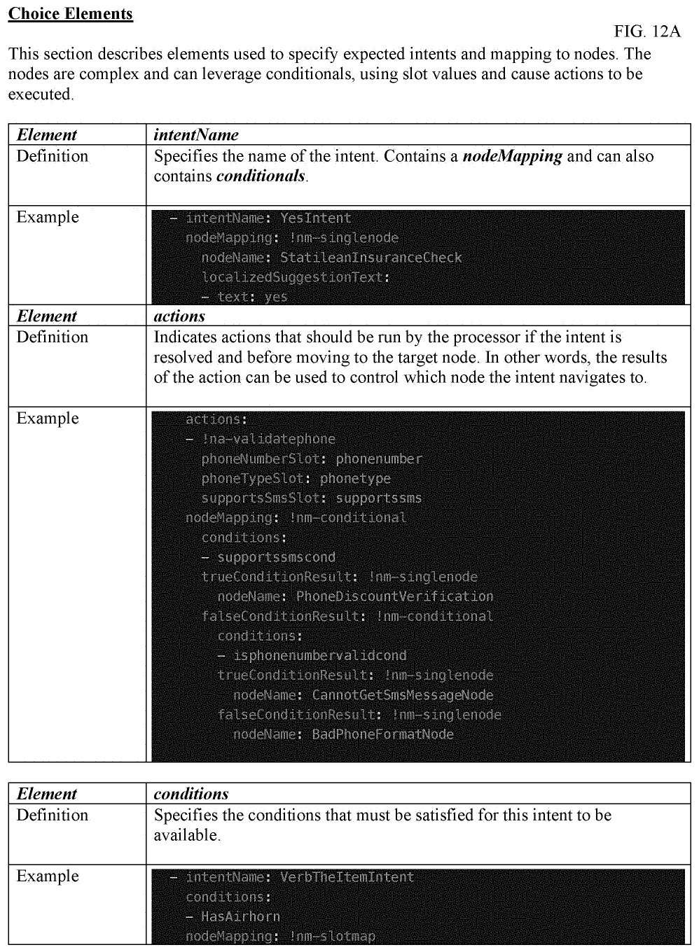

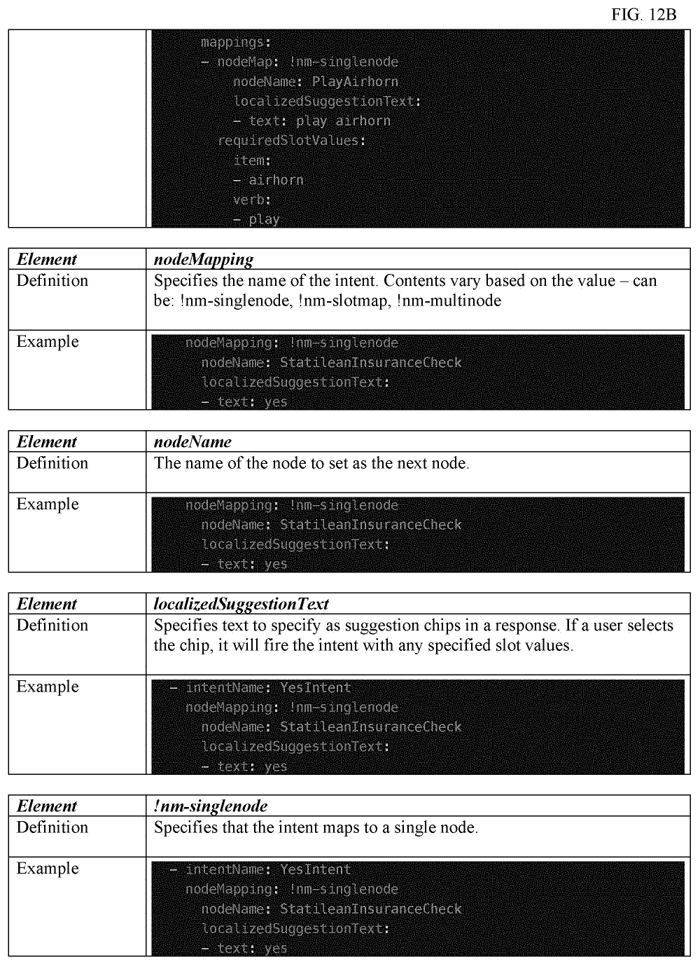

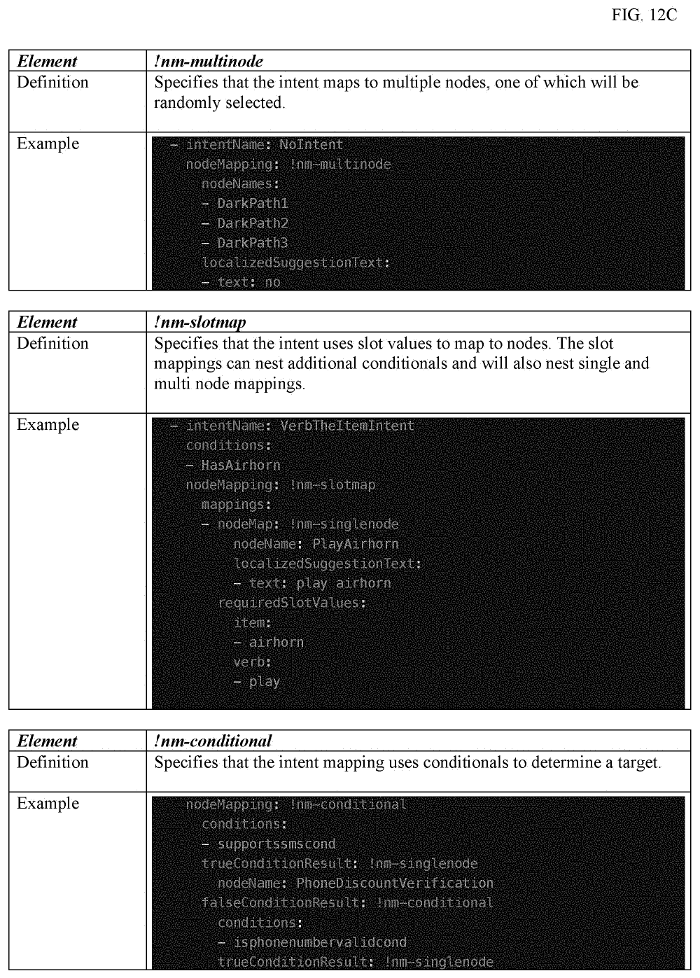

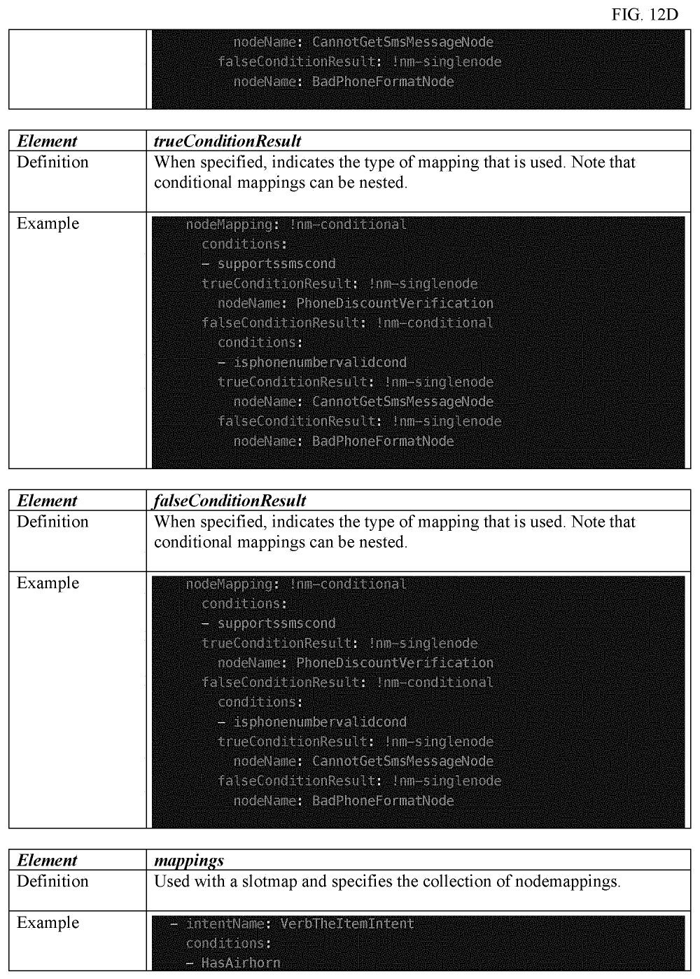

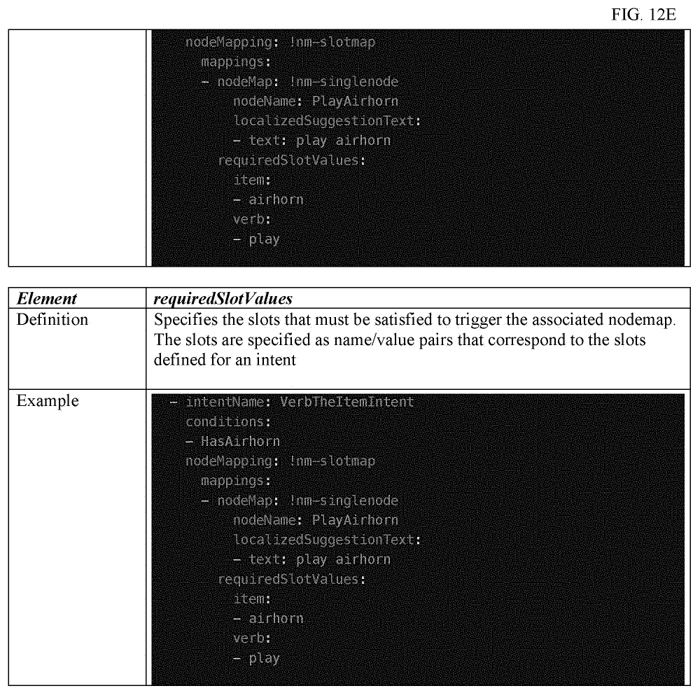

FIGS. 12A-12E show choice elements of the Script MetaData with examples;

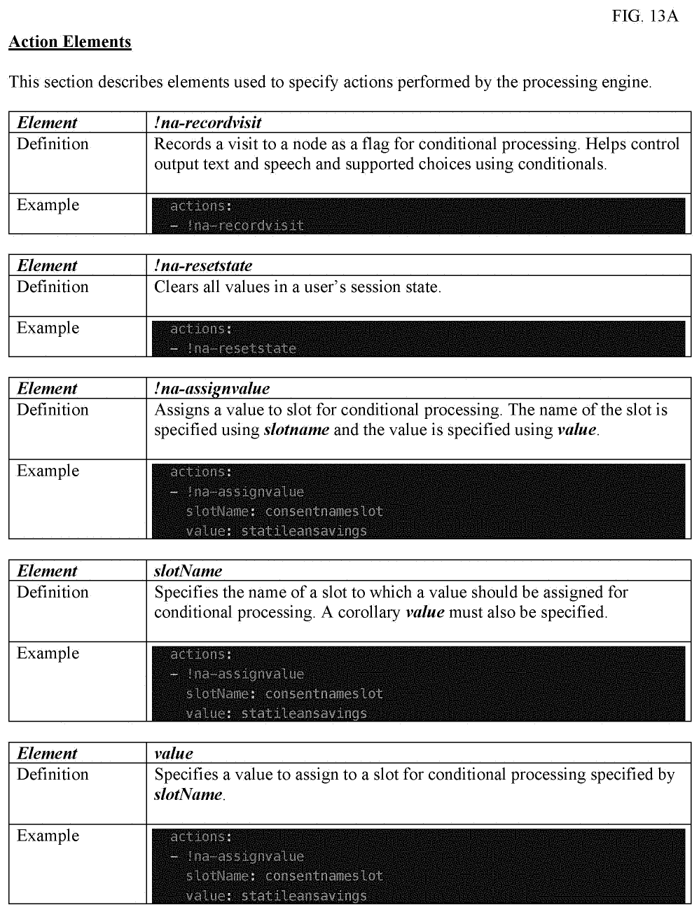

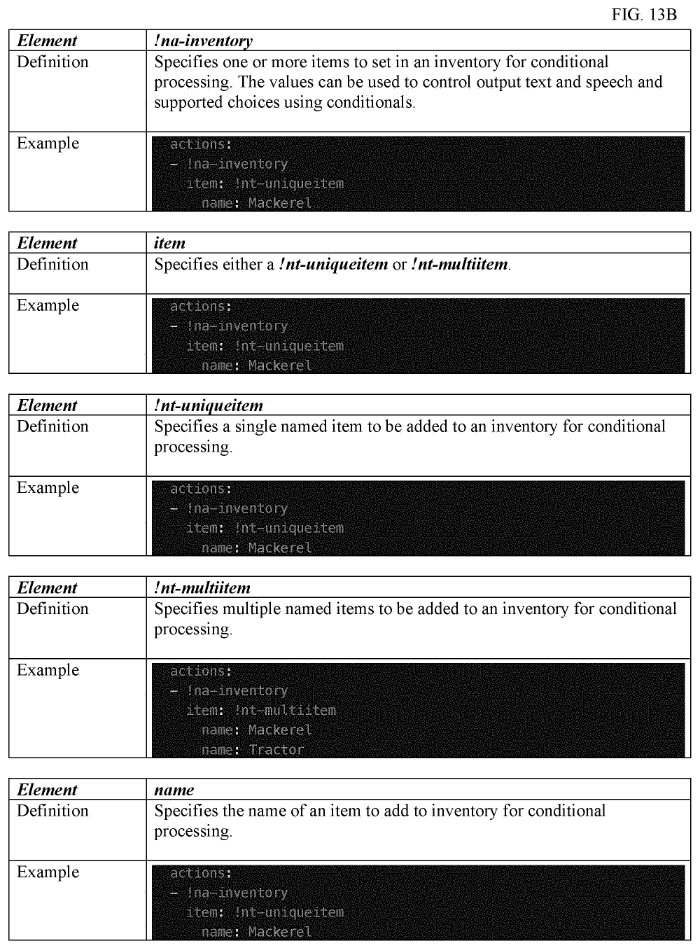

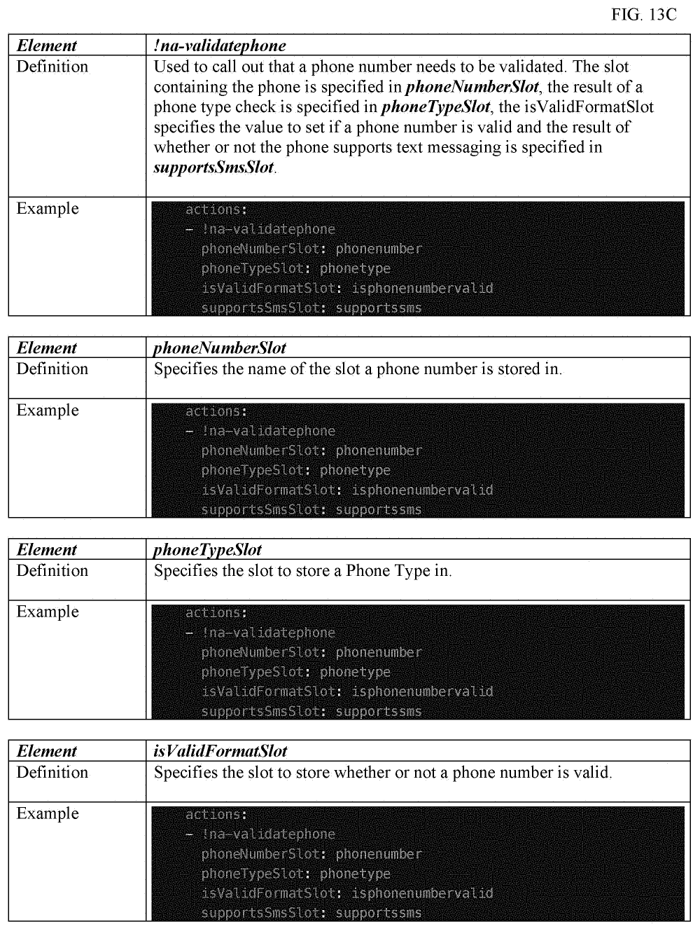

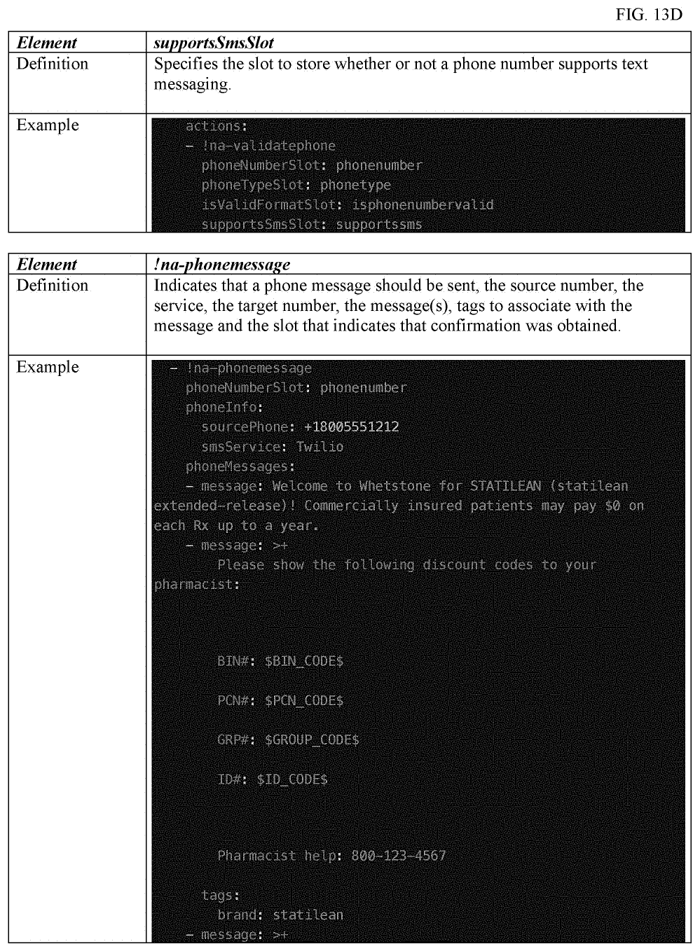

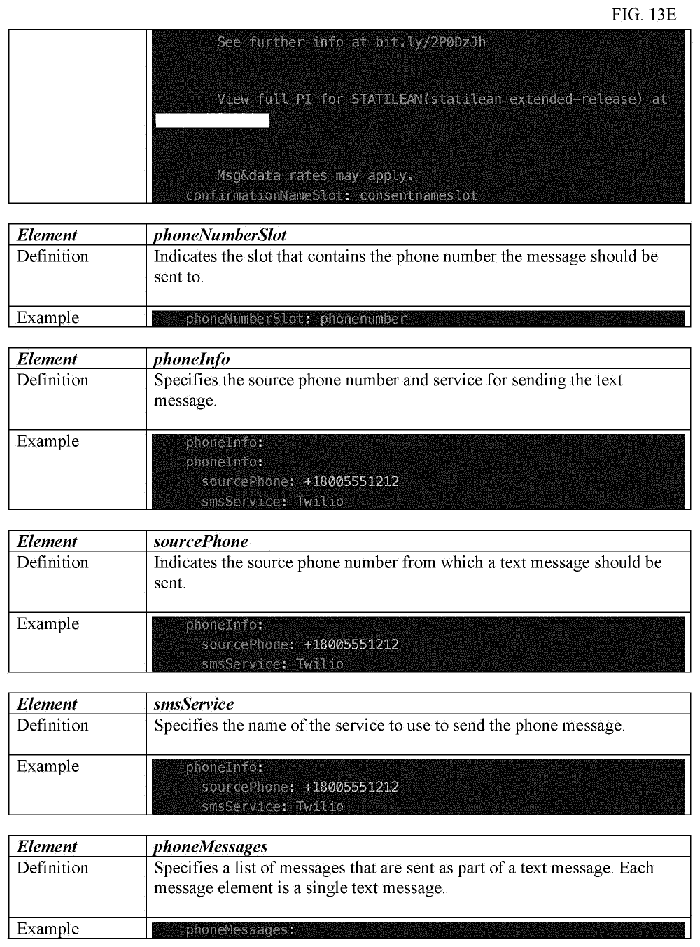

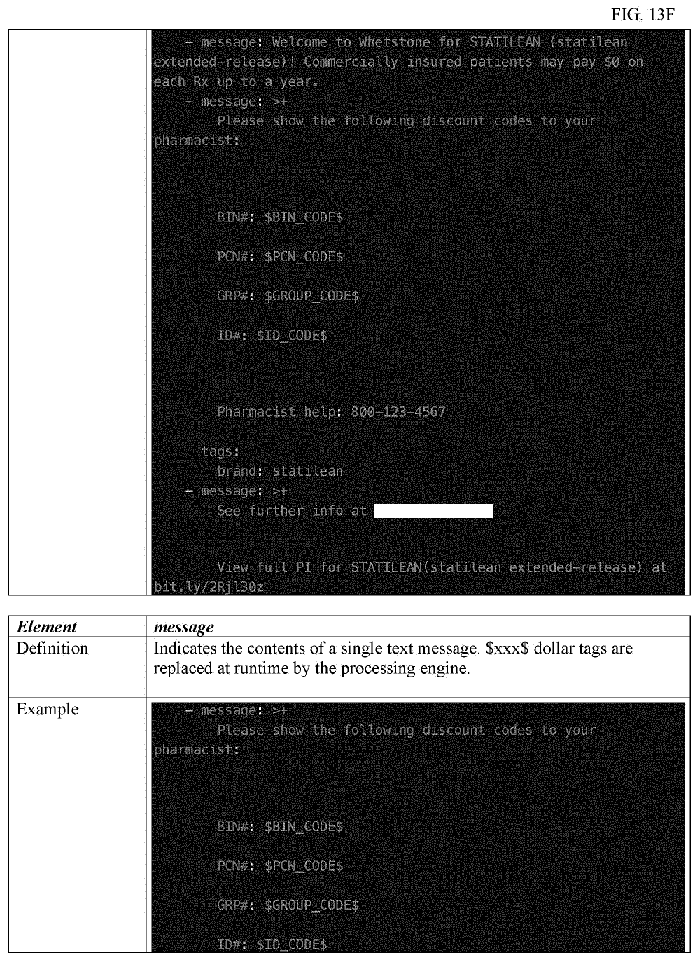

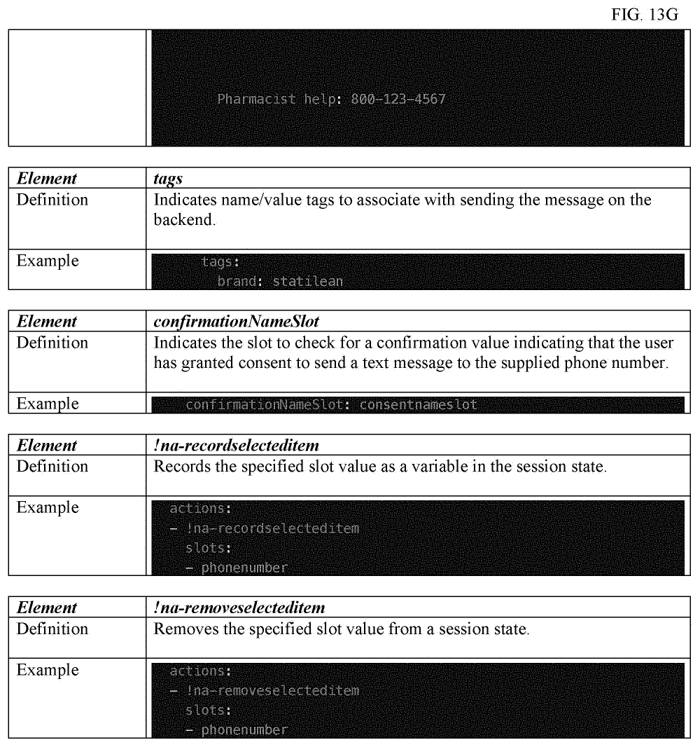

FIGS. 13A-13G show action elements of the Script MetaData with examples;

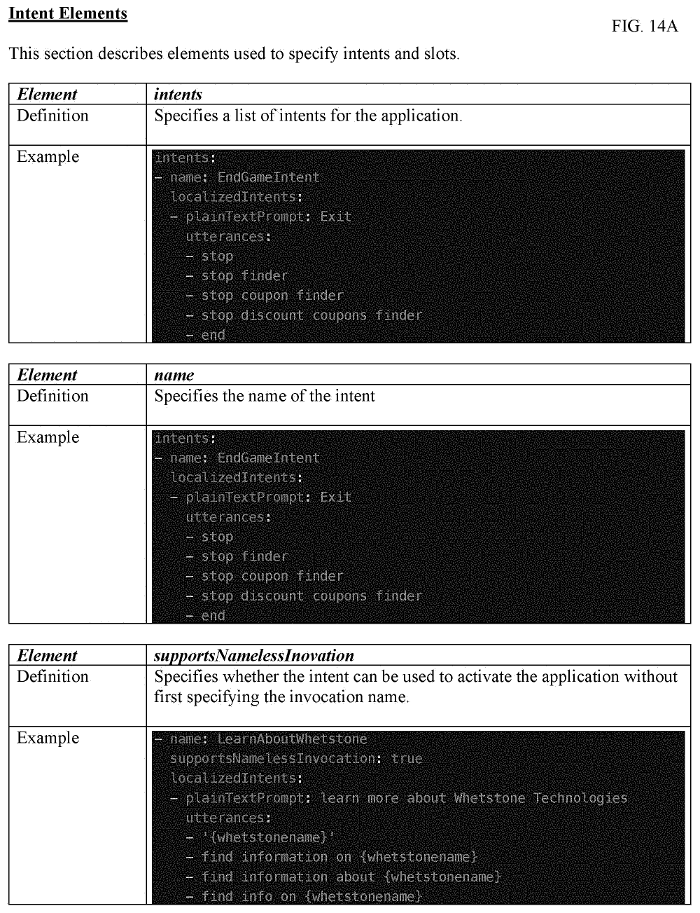

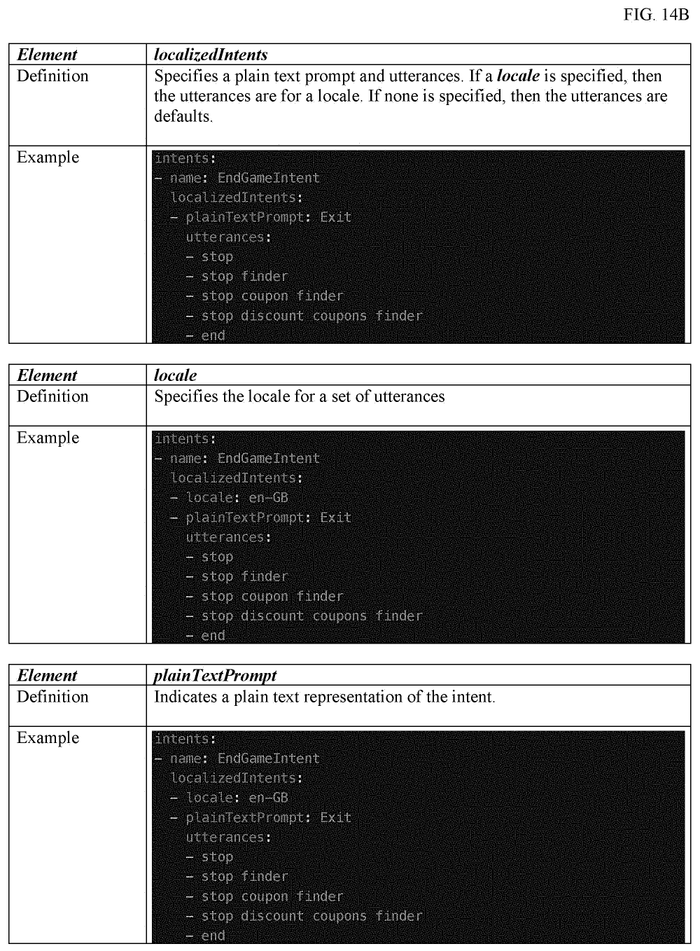

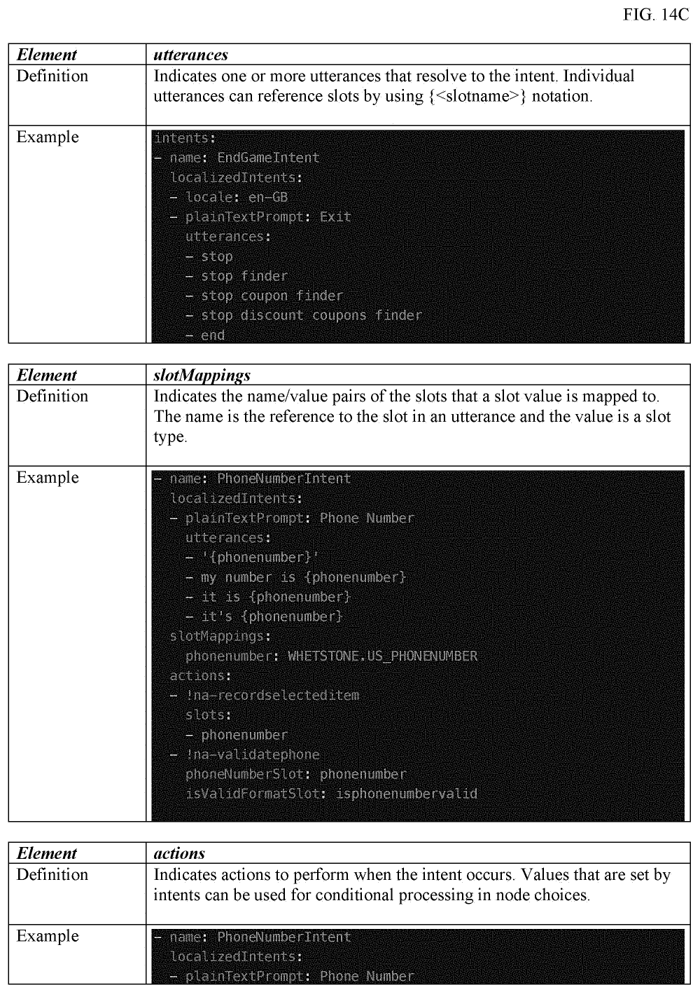

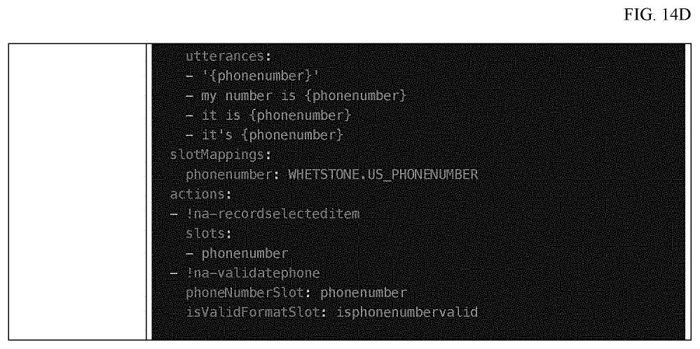

FIGS. 14A-14D show intent elements of the Script MetaData with examples;

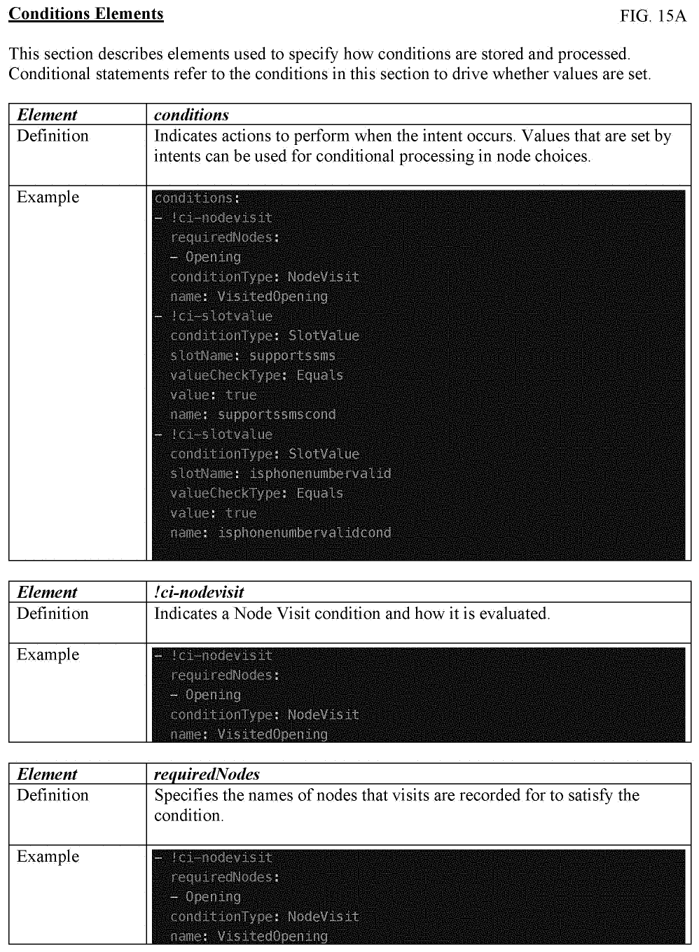

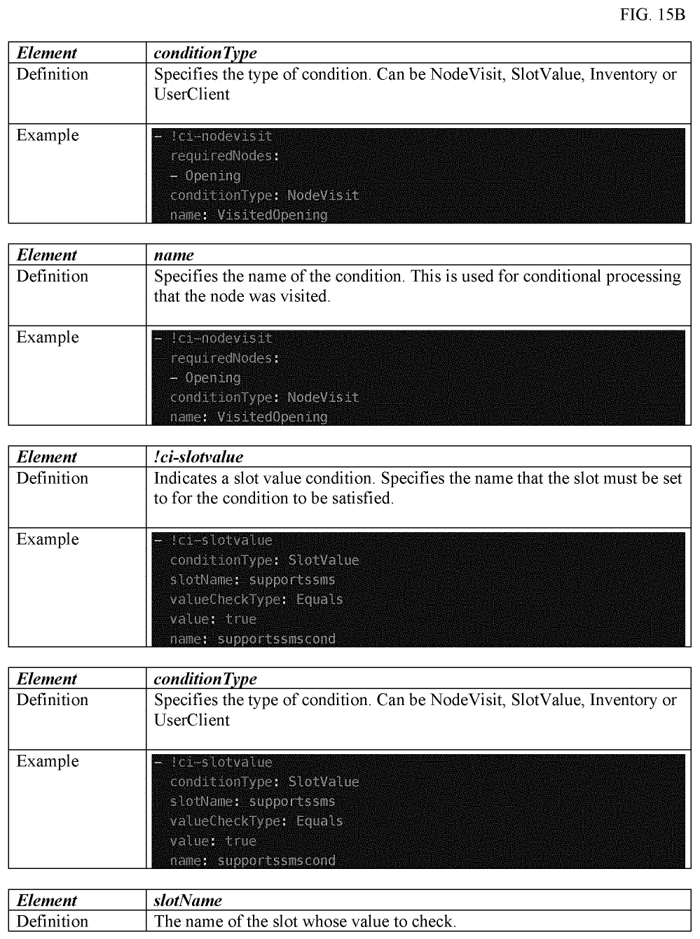

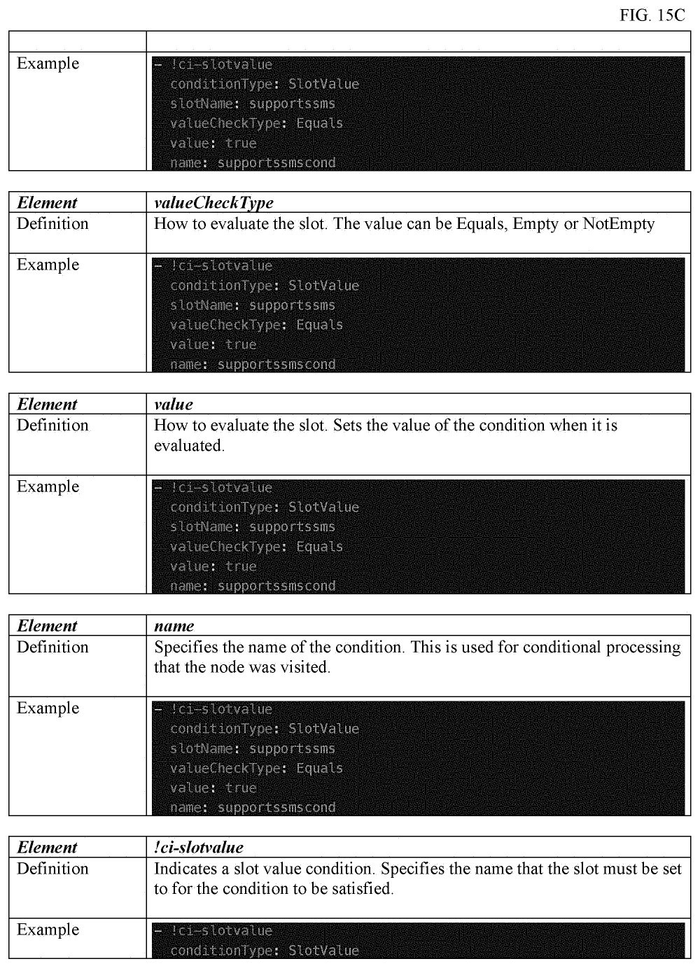

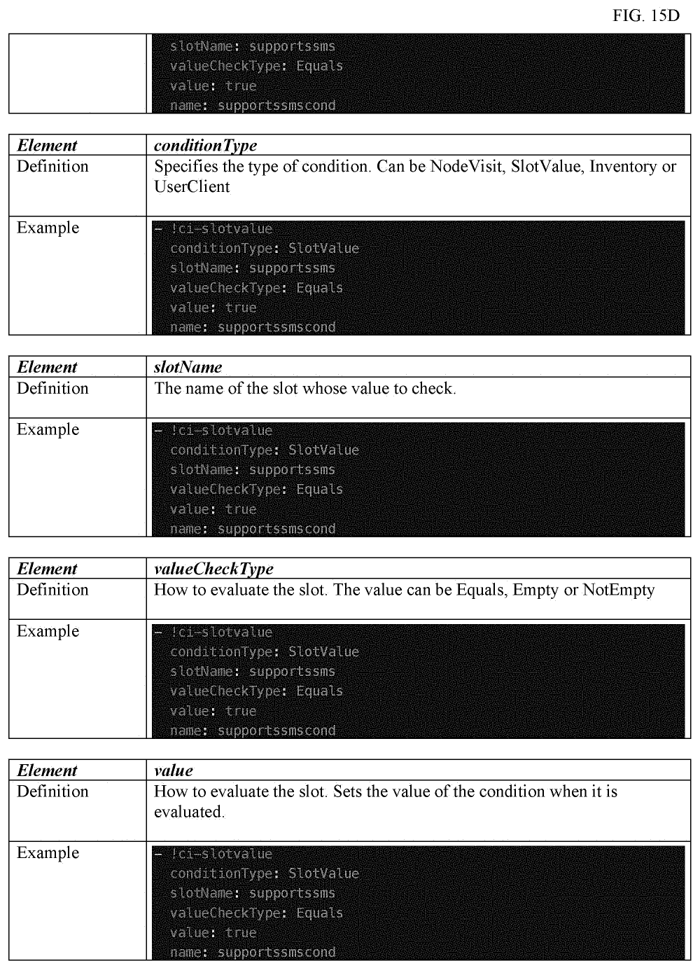

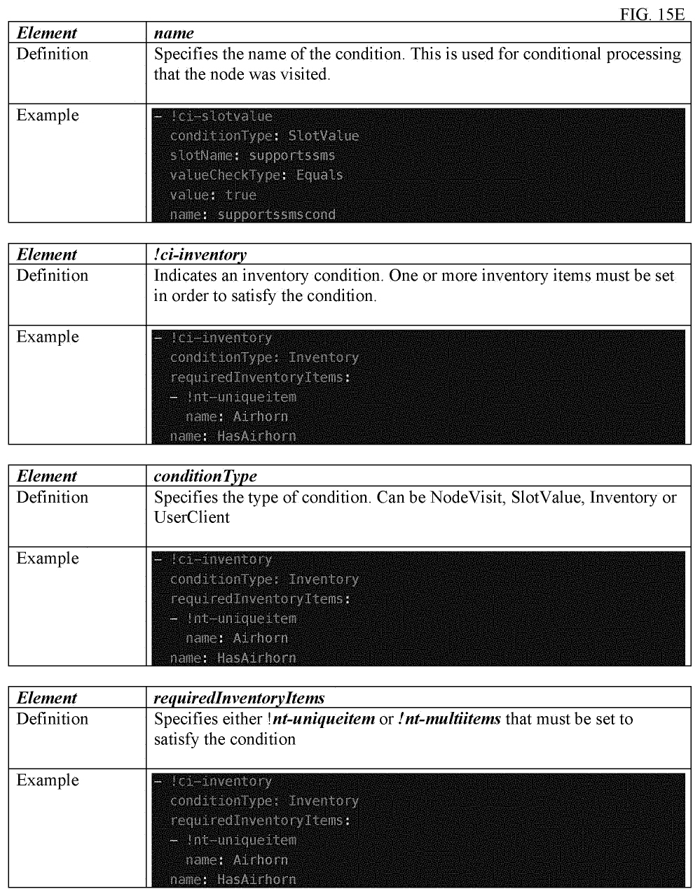

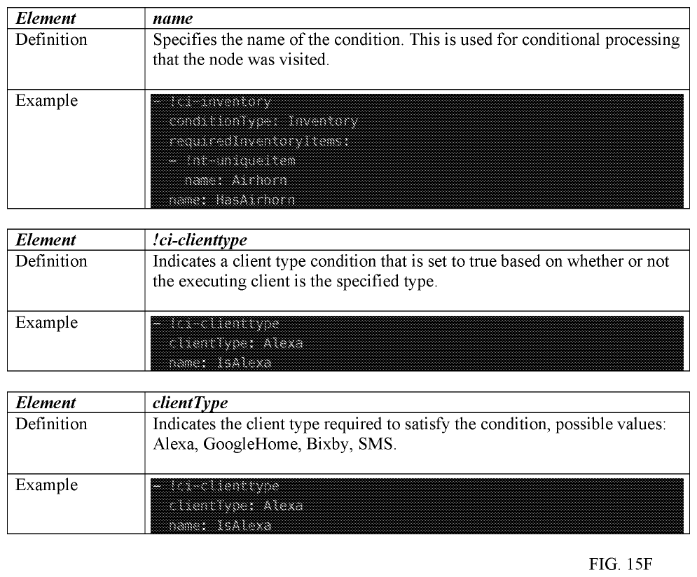

FIGS. 15A-15F show conditions elements of the Script MetaData with examples;

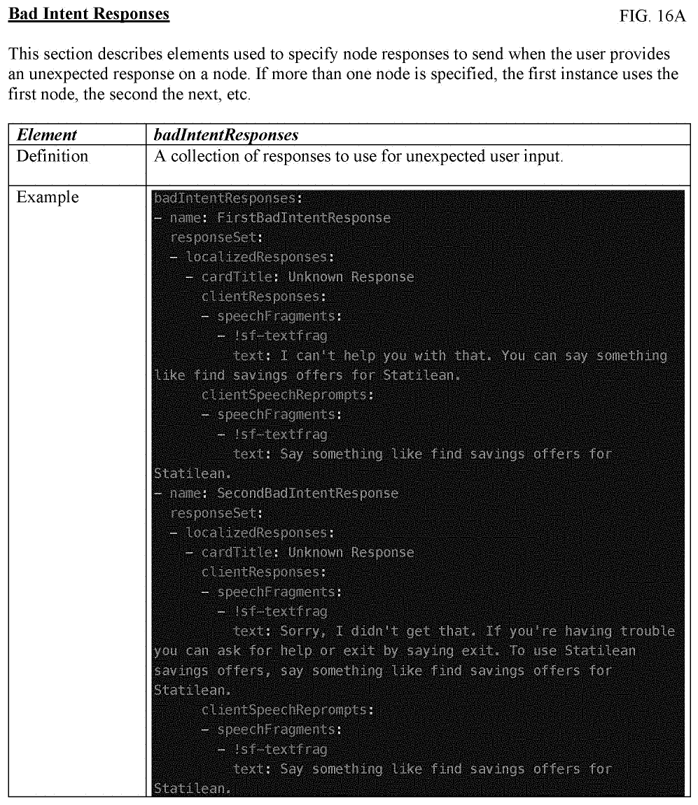

FIG. 16A shows bad intent elements of the Script MetaData with examples; and

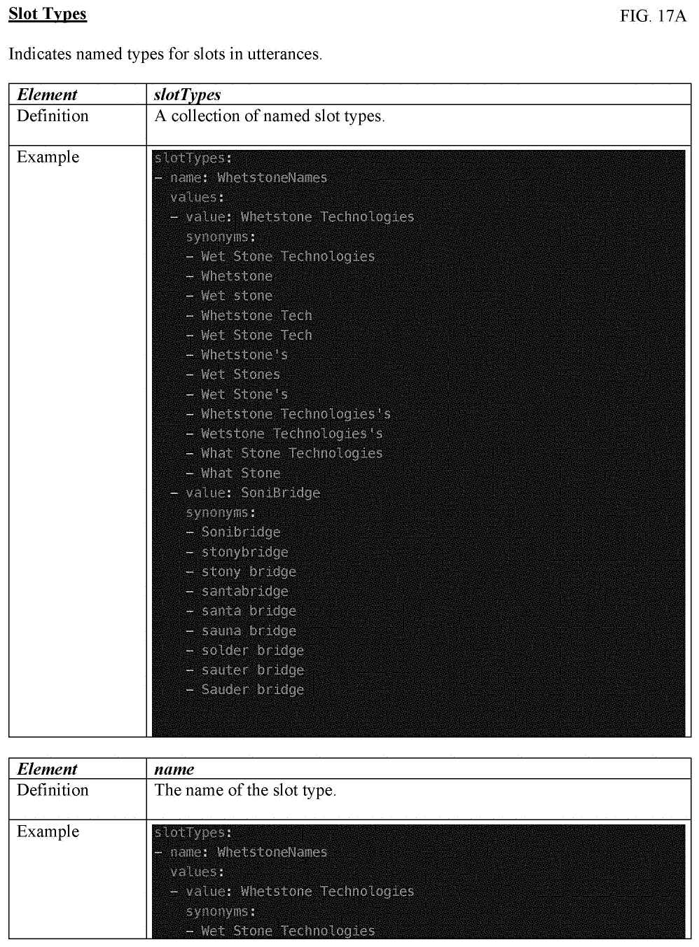

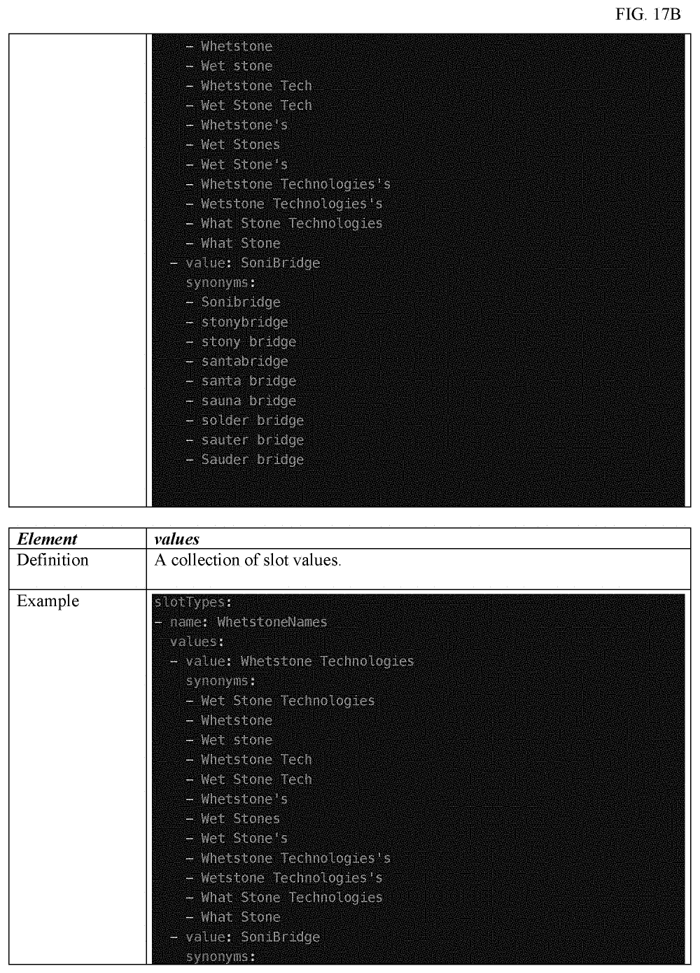

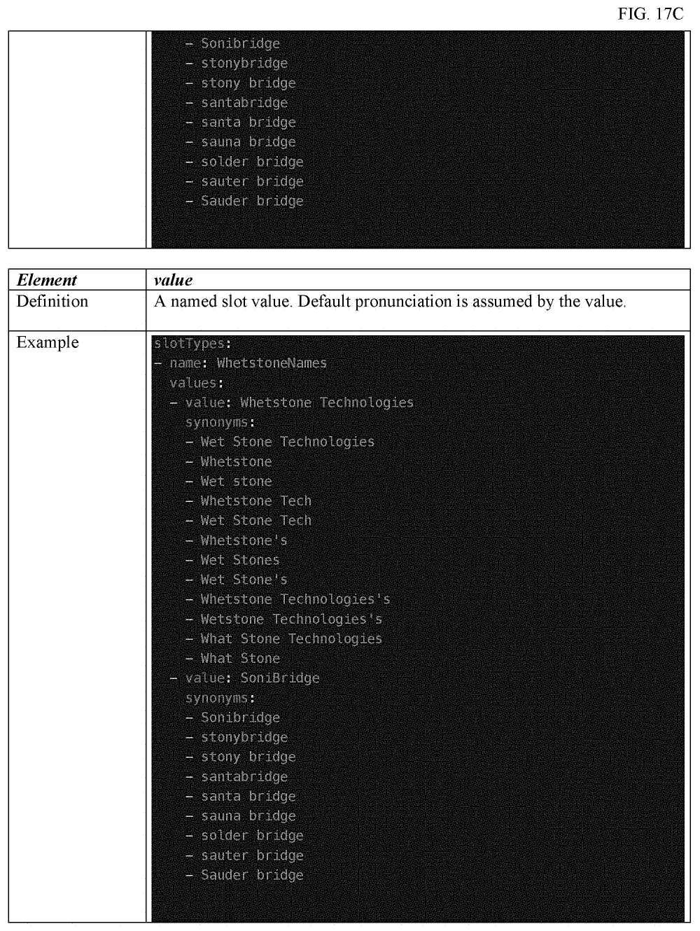

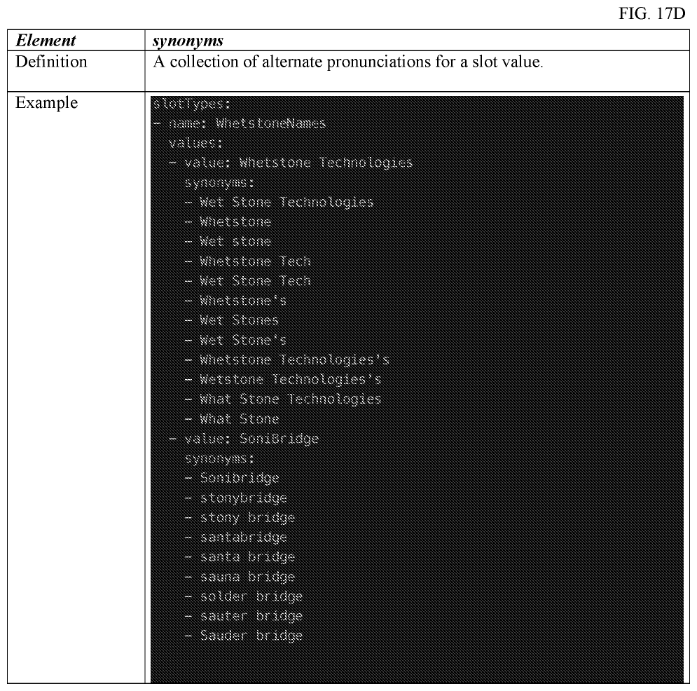

FIGS. 17A-17D show slot elements of the Script MetaData with examples.

For performance reasons, the metadata may be stored in a cache at runtime, although it could easily be stored in a database and rehydrated as well. For the purposes of the elements noted above, the elements are described using a YAML format, though this is not limiting.

In addition to, and summarizing some of the elements in the figures worth noting, some basic elements that define the application may include things like those described below and also application id, title, description, version, invocation name and calling out any special response nodes, like start node, first time user node, help node, etc.

Response Node Elements

Response Nodes are named elements that describe responses that are sent back to the client platform. Responses may include card elements, speech elements, action elements, and a set of supported navigation elements for the current response node that direct the application to other response nodes driven by the user's intent.

Further, response elements may be localized based on the user's language as well as the voice platform (e.g. Alexa or Google Home). This lets the platform engine accommodate multiple languages as well as different responses for Alexa, Google Actions, and other voice platforms.

Card Elements

For NLP platforms that have screens, there may be an ability to send responses that have visual elements consisting of images and text that may be displayed to an end user. Card elements may use conditional statements to further control how a response is built based on values that are stored in the user's context.

Speech Elements

For NLP platforms that support audio, speech elements control what the NLP platform will speak in response to a user's NLP input. A special type of speech element may be a reprompt that controls what the NLP platform should say if a user doesn't respond for a platform driven amount of time. Speech elements may use conditional statements to further control how a response is built based on values that are stored in the user's context.

Action Elements

When a node is processed there is opportunity to direct the platform engine to execute actions such as validating a phone number, clearing user data, storing values in named variables, etc. Action elements may be defined as both pre-processing actions and post-processing actions. Pre-processing actions execute before processing a node. Post-processing actions run after a node is processed, but before a response is returned to the user.

Action elements may be extensible. The platform engine may use actions to invoke other business applications and consume data from various data sources.

Navigation Elements

Navigation elements may be defined on Response Nodes and use intents to determine the next response node to use to send a response to the user. Navigation elements may use conditional processing to control which intents are valid for the current response node, based on the user's application context.

Condition Elements

Condition elements are named elements that may be used to check state or return values so that an application may control flow or the response data that is sent back to a user based on their context.

Condition elements may also be placed on actions so that actions may be executed or not executed.

Intent Elements

Intent elements are named elements that define different utterances or ways for a user to provide input that all resolve to that intent. For example, a “Yes” intent may include the following utterances: “Yeah”, “Yes”, “Uh-huh”, “Sure”. Utterances may also define placeholders for slots. Intents may also have actions associated with them, that are fired whenever a user responds with the intent, when the intent is valid for the current response node.

Slot Elements

Slot elements are named data types that imply a certain type of input. For example, a slot called Tool might may include “Hammer”, “Drill” and “Saw”. Each of the slot values may have synonyms that define alternative pronunciations for the value.

Bad Response Elements

When a user provides input that is not understood by the current node, or input that cannot be resolved to an intent, a bad response is returned. If multiple bad responses are defined, then the engine will vary responses by iterating through the available bad responses.

Request Processing Overview

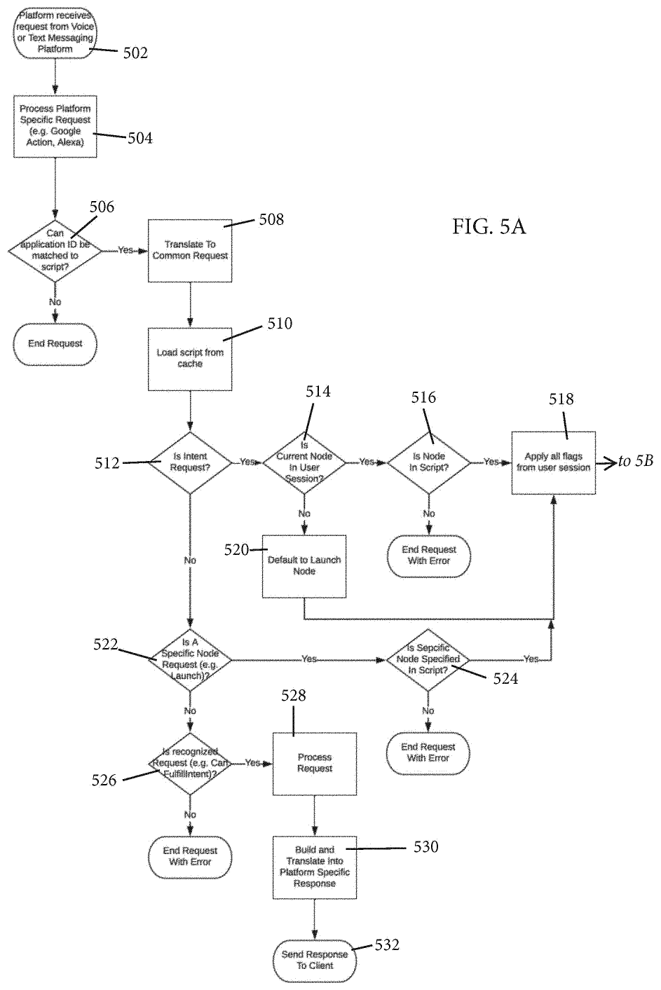

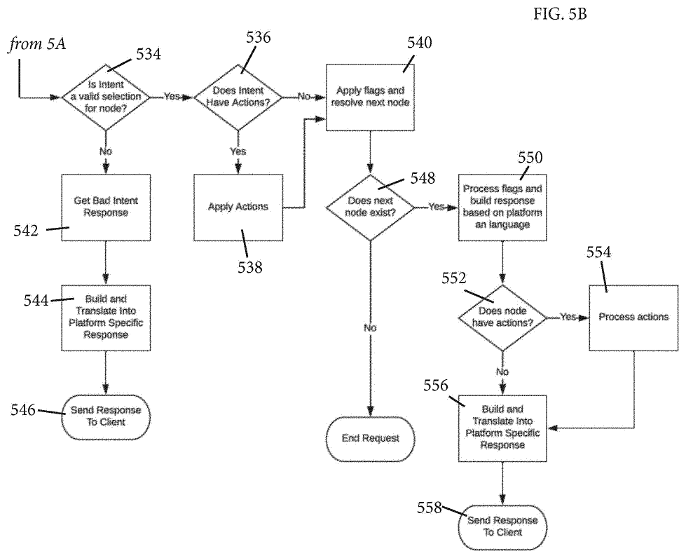

FIGS. 5A and 5B show a logic flow through the scripting logic where the platform engine is a back-end request/response system that receives user requests and supplies responses. Requests may be pre-processed by an NLP platform like Amazon Alexa, Google DialogFlow, Samsung Bixby or Microsoft's Cortana, or raw input such as text messaging. This is the NLP client.

Regardless of how the initial input comes in, the request processing may be the same.

This section will describe the general flow of request into the system and generation of a response.

1—NLP Client endpoint is called in a voice request 502 and processes it based on its platform 504.

2—The application id from the request is mapped (or not, resulting in an end to the request and ends with an error) to a script version and YAML script 506.

4—The client-specific request is translated into a common request format 508.

5—The YAML script associated with the mapped version is loaded from the cache 510.

6—The request is inspected to determine if it is an intent request 512, and if it is, a current node is pulled from the user's application store and there is a check to see if the current node is in a user session 514 and if it is, there is a check if the node is in script and if it is, all flags are applied from the user session 518.

If the node is not in script the script returns an error. If the current mode is not in user session, there is a default to launch node 520 and the script returns to the apply all flags from user session step 518.

If the request is not an intent request 512, the script checks if it is a specific node request (like a launch) 522, and if it is, the script checks if the specific node is specified in a script (if not, the script responds with an error) 524, and if it is, all flags are applied from the user session 518.

If the request is not a node request, the script checks if it is a recognized request 526, and if yes, it is processed 528, builds and translates it into a platform specific response 530 that is sent to the client 532. If the request is not a node request, the script returns an error.

After the script applies all flags from a user session 518, the script checks whether the intent is a valid selection for a node 534. If it is, the script checks whether the intent has actions 536, and if yes, applies them 538, at which point the script may apply flags and resolve the next node 540.

If the intent is not a valid selection 534, the script retrieves a bad intent response 542, builds an translates the response into a platform-specific response 544, which is sent to the client 546.

After the script applies flags and moves to resolve the next node 544, it first checks that the next node exists 548 (if it doesn't, the request ends), and if it does, the script processes flags and builds a response based on the platform language 550. It then checks if the node has actions 552, and if it does, processes them 554, and builds and translates those into a platform-specific response 556, and sends the response to the client 558.

Extensibility

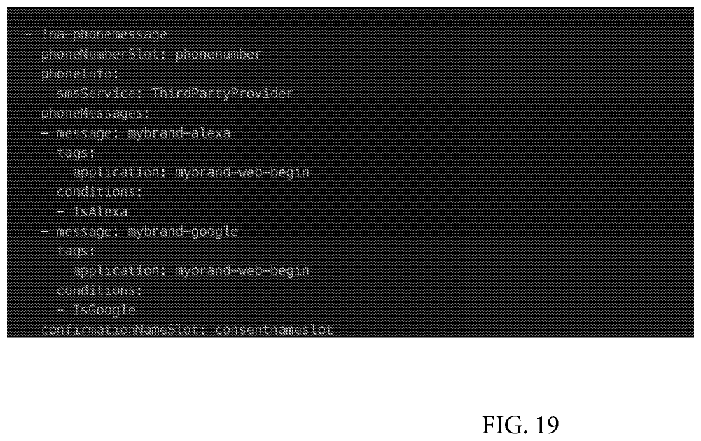

As shown in the sample YAML script shown in FIG. 19, the platform may extend or “bridge” into other third-party services without disrupting the main architecture. For example, if a customer that offers discounts that might be provided in responses has an existing service/fulfillment infrastructure already in place, new actions or entities may be defined introduced into the script that will tell the processing engine to call into the new infrastructure. This may be done naturally and without disrupting existing script processing.

From a user perspective, a first party may perform the text messaging and text messaging consent, a second party may perform the voice implementation, get the phone number, and further consent, with responsibilities may shift between the parties or taken by a new third party, thus providing a system that requires little reprogramming as users exchange responsibilities.

Example YAML Script

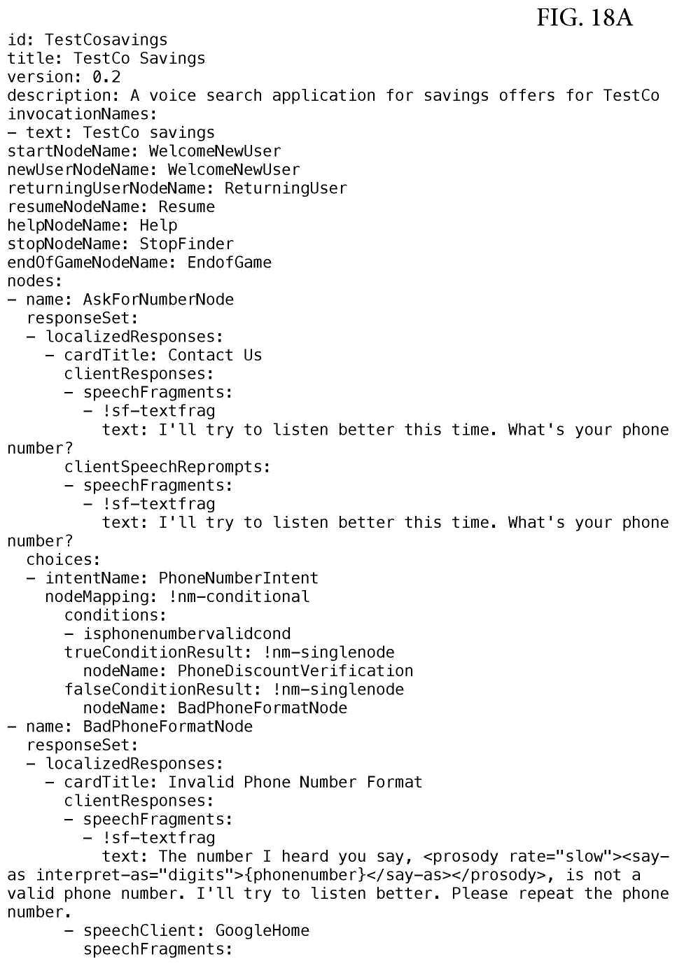

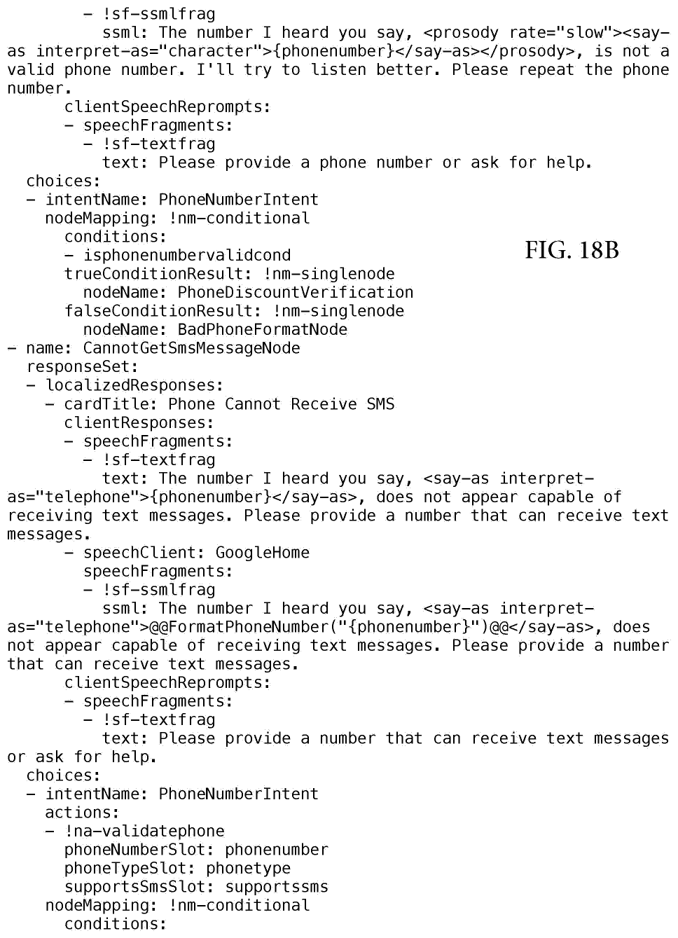

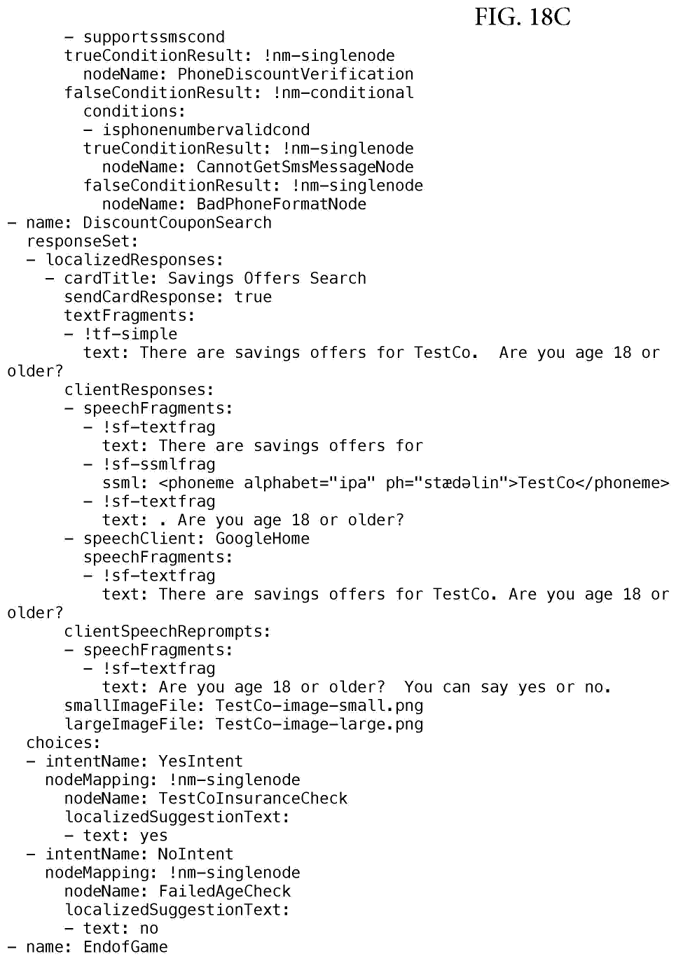

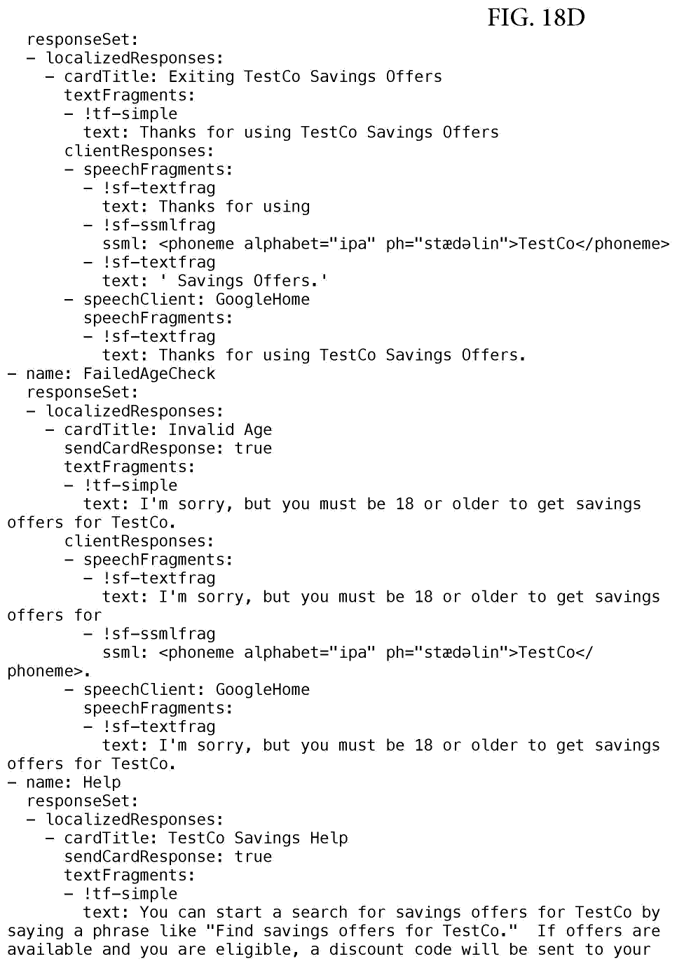

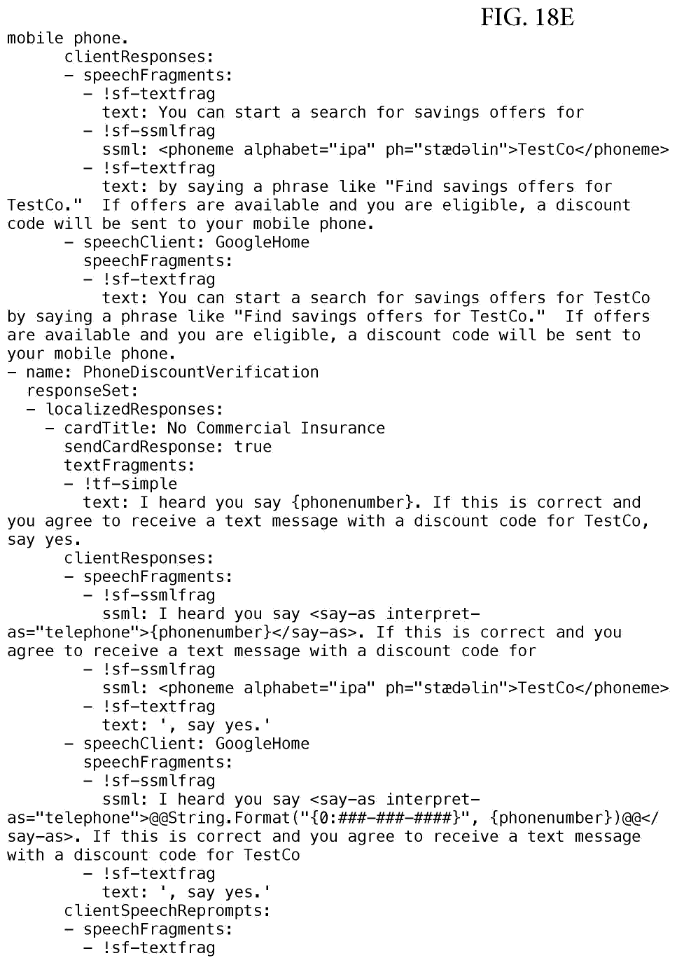

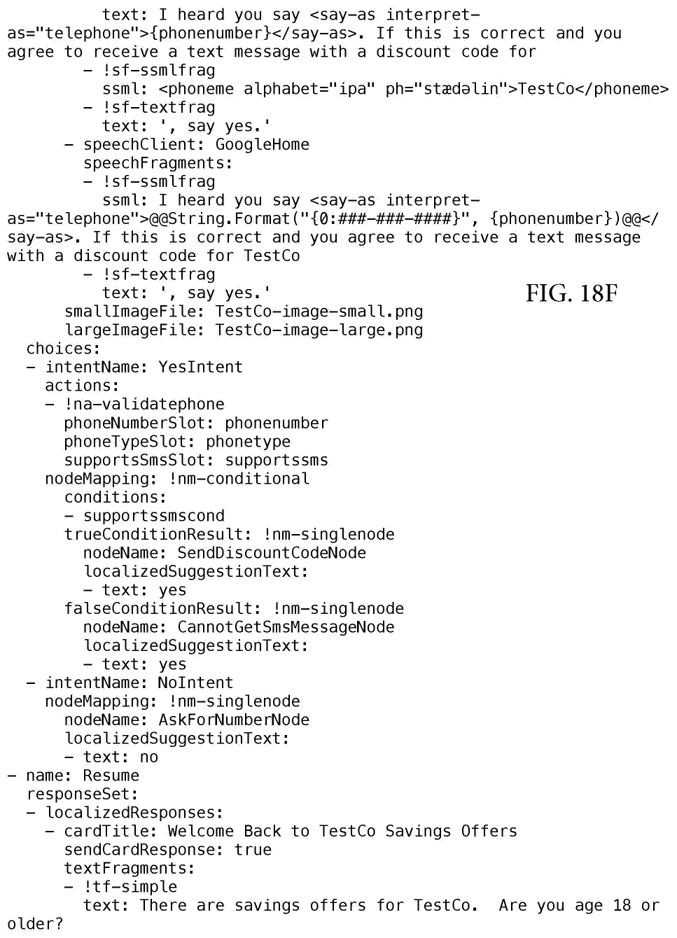

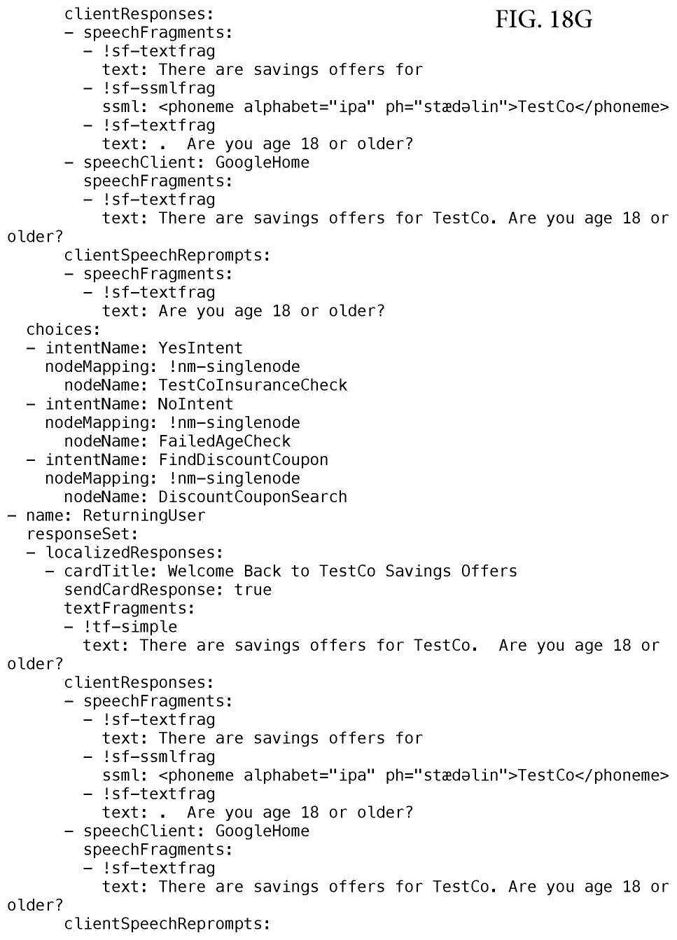

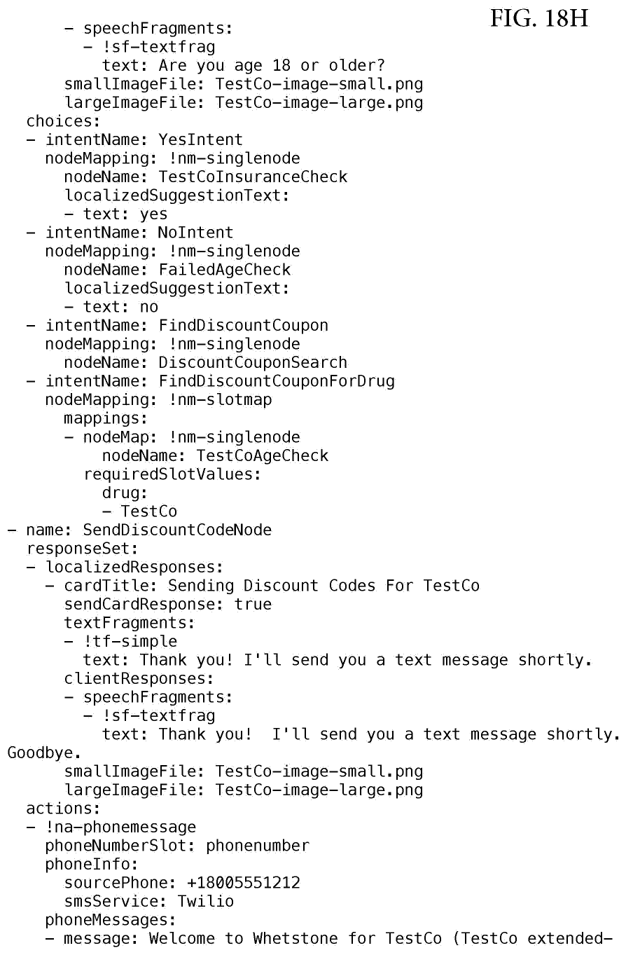

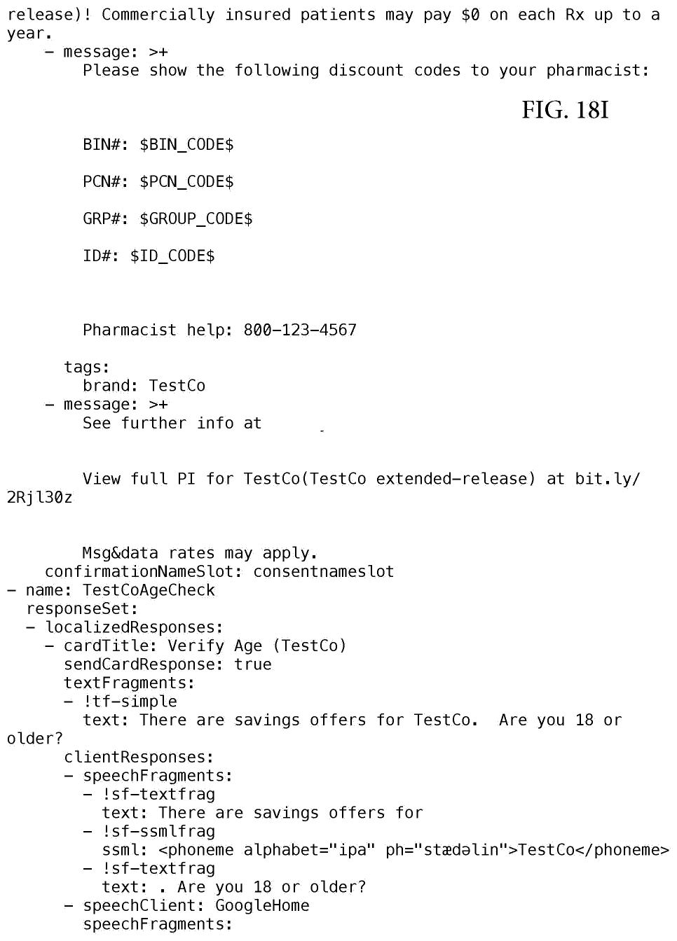

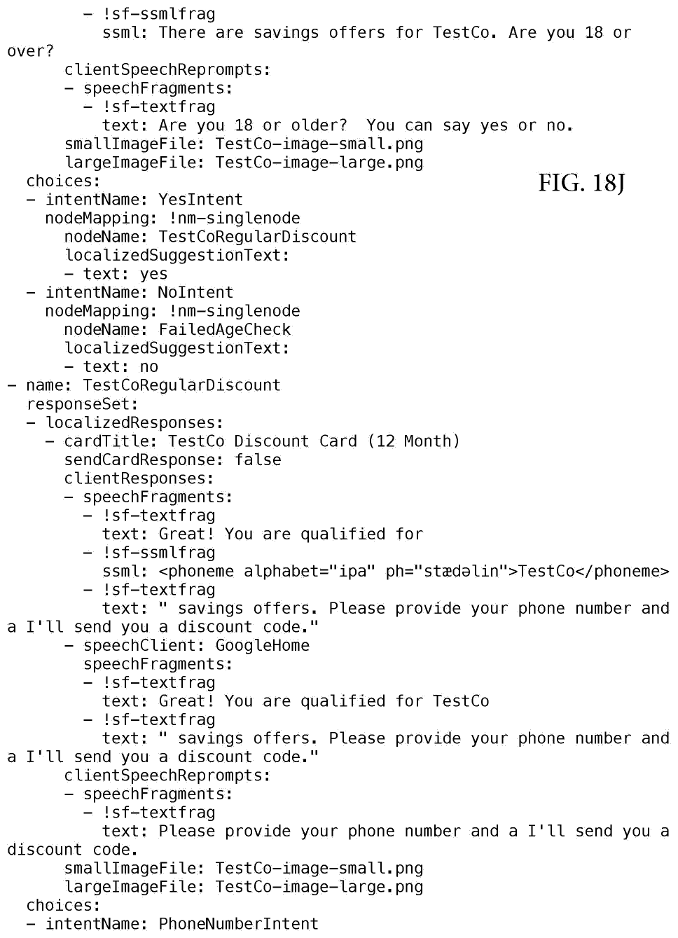

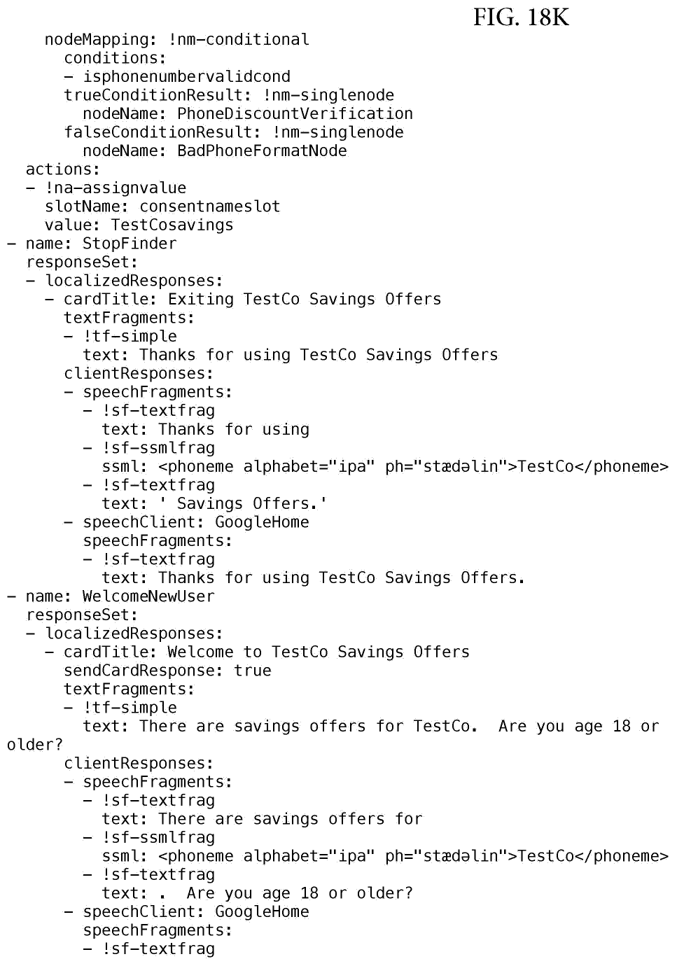

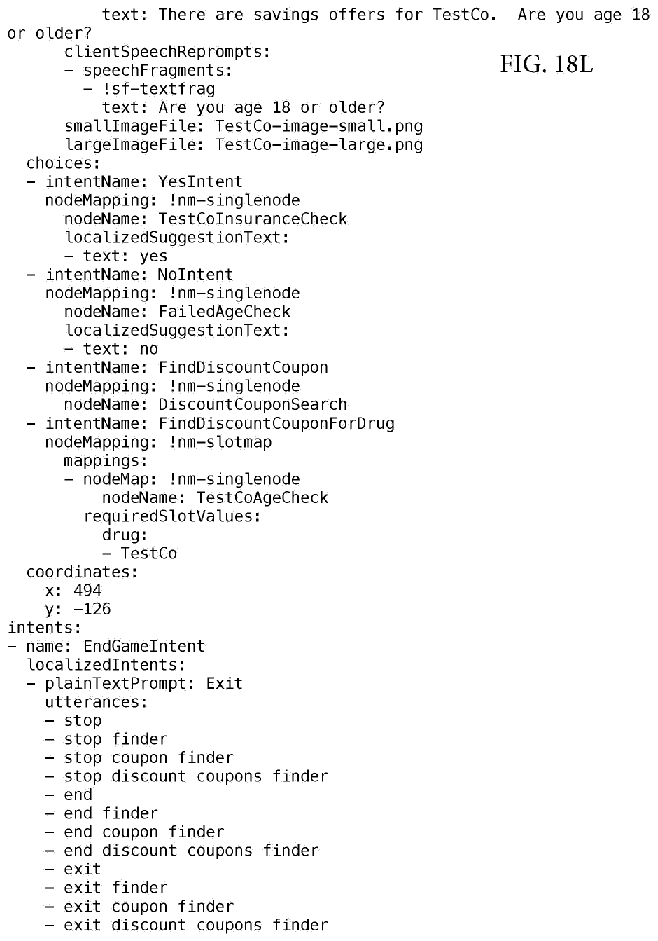

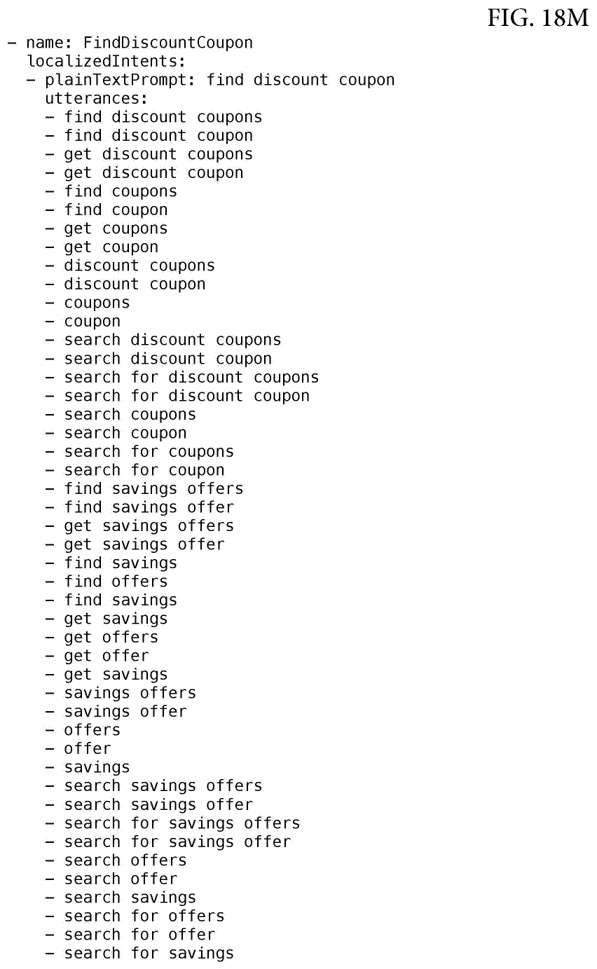

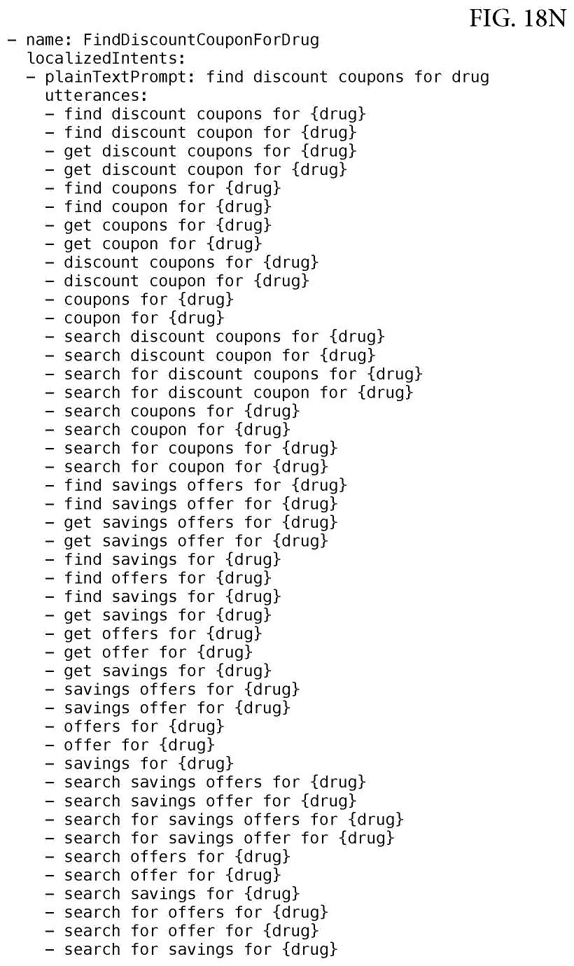

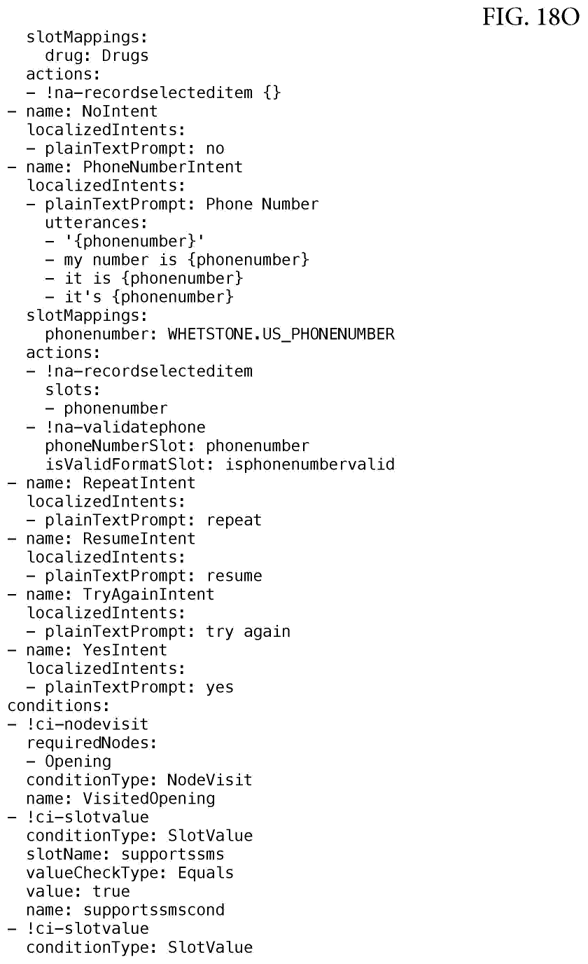

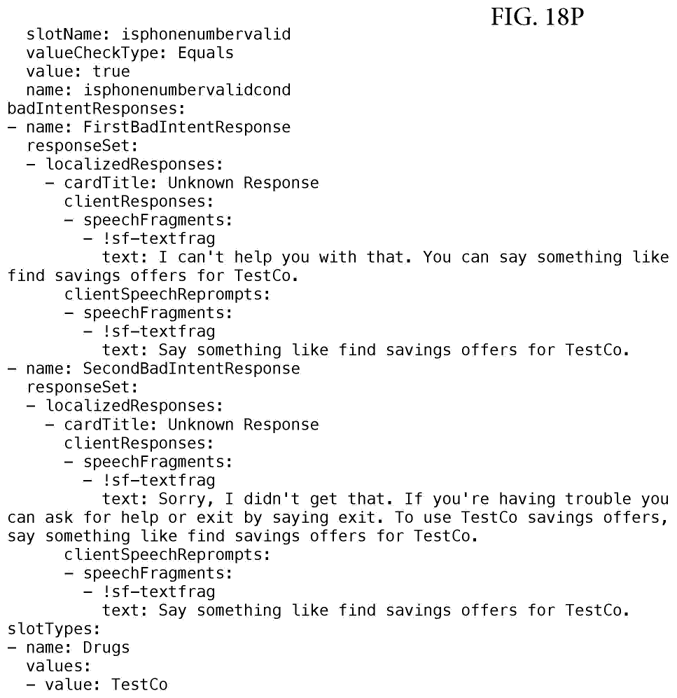

FIGS. 18A-18P show a sample YAML script that shows a single text message application using a “TestCo” voice-first marketing fulfillment workflow as described herein. The script is easily followable to a person of skill in the art, but as an overview generally it provides nodes that:

ask for a contact number (AskForNumberNode)

returns responses if the number is bad (BadPhoneFormatNode)

respond when a message cannot be sent (CannotGetSmsMessageNode)

search for relevant coupons (DiscountCouponSearch)

end an interaction (EndofGame)

notify the user of a failed age check (FailedAgeCheck)

provide help to the user (Help)

verify phone number (PhoneDiscountVerification)

resume an earlier session (Resume)

recognize a returning user (ReturningUser)

send a discount code (SendDiscountCodeNode)

verify a user age with the TestCo (TestCoAgeCheck)

confirm that the TestCo is providing a discount (TestCoRegularDiscount)

stop finding discounts (StopFinder)

welcome a new user (WelcomeNewUser)

The script also defines various intents (starting at FIG. 18L).

defines nodes that as

Although messages have mostly been described as MMS and SMS, the system could use other message formats like RCS, and similarly, the system is not limited to using Lambda.

While the invention has been described with reference to the embodiments above, a person of ordinary skill in the art would understand that various changes or modifications may be made thereto without departing from the scope of the claims.

1. A voice interface platform comprising:
a script processing engine that interprets user intent arising from a user request using a script, and using the script defines how applications respond to the user requests based on the user intent; wherein the script defines how the applications respond based on a platform on which the user request originates; wherein the platform can deliver the response using the platform from which the user request originates or another platform.

2. The voice interface platform of claim 1, further comprising a natural language (NLP) platform that processes the user requests.

3. The voice interface platform of claim 1, wherein the user request includes an application id.

4. The voice interface platform of claim 3, wherein the script processing engine maps the application id to a script.

5. The voice interface platform of claim 4, wherein the script is a YAML script.

6. The voice interface platform of claim 4, wherein the script processing engine reviews the user request to determine if it is an intent request, and if it is, a current node is pulled from the user's application store and a check is performed to see if the current node is in a user session.

7. The voice interface platform of claim 6, wherein if the current node is in a user session, the script processing engine checks if the current node is in script and if it is, flags are applied from the user session.

8. The voice interface platform of claim 7, wherein after application of the flags, the script processing engine checks if the current node has actions and if it does, translates the actions into a response.

9. The voice interface of claim 1, wherein the response is a text message.

10. The voice interface of claim 9, wherein the text message includes discount codes.

11. A platform for voice applications comprising:
a collection system that collects customer information including user preferences and a mobile number, wherein some of the information is collected using a user's voice; and
a delivery system that delivers information related to the user preferences to the mobile number via a message.

12. The platform of claim 11, wherein the message is a text message.

13. The platform of claim 11, wherein the message includes multimedia content.

14. The platform of claim 11, wherein the message includes discount codes.

15. The platform of claim 11, wherein the message includes a web link.

16. The platform of claim 11, wherein the user preferences include user requests for marketing materials and the delivered information includes discounts related to the user preferences.

17. The platform of claim 11, wherein the delivery system does not deliver information unless the user consents to such delivery.

18. The platform of claim 11, wherein the user may opt out of delivery of information.

19. The platform of claim 11, wherein the collection system uses a smart speaker or other voice platform enabled device to interact with the user.

20. The platform of claim 11, wherein at least some of the user preferences and information related to the user's preferences are stored remote from the smart speaker or other voice platform enabled device.
